(19) United States
(12) Patent Application Publication
(10) Pub. No.: US 2026/0120396 A1
(43) Pub. Date: Apr. 30, 2026

(54) Generation of Reconstructed Three-Dimensional Representations

(71) Applicant: Google LLC, Mountain View, CA (US)

(72) Inventor: Charles Goran, Lafayette, CO (US)

(21) Appl. No.: 18/925,990

(22) Filed: Oct. 24, 2024

(51) Int. Cl. G06T 17/00; G06T 19/00

(52) U.S. Cl. CPC G06T 17/00; G06T 19/003; G06T 19/006

(57) ABSTRACT

Methods, systems, devices, and non-transitory computer readable media for generating reconstructed three-dimensional representations are provided. The disclosed technology can include receiving image data comprising two-dimensional images associated with a path through a physical space. Based on the image data, a plurality of scan nodes associated with the path can be determined. The plurality of scan nodes can comprise locations at which to capture a plurality of two-dimensional scanned images of the physical space. Based on the plurality of scan nodes, a plurality of instructions associated with capturing the plurality of two-dimensional scanned images of the physical space can be generated. Based on the plurality of instructions, the plurality of two-dimensional scanned images associated with the plurality of scan nodes can be generated. Furthermore, based on the image data and the plurality of two-dimensional scanned images, a reconstructed three-dimensional representation of the physical space can be generated.

### FIELD

The present disclosure relates generally to generating reconstructed three-dimensional representations based on two-dimensional images. More particularly, the present disclosure relates to using augmented reality technology in the process of capturing images that are reconstructed based on rasterization-based techniques or implementation of machine-learned models configured to generate reconstructed three-dimensional representations.

### BACKGROUND

Images can be processed in a variety of different ways. Further, different processes can be used to process or otherwise modify certain features of images. In some cases the images can include images of an environment and the techniques used to process the images can emphasize certain features of the environment depicted in the images. However, the choice of techniques used to process the images can vary depending on the type of environment depicted in the images. Further, the types of techniques that are used to process the images can depend on the application that uses the images. As a result, the effectiveness of image processing techniques may depend on the content of the images provided as input. Accordingly, there may be different approaches to processing images.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of generating reconstructed three-dimensional representations. The computer-implemented method can comprise receiving, by a computing system comprising one or more processors, image data comprising a plurality of two-dimensional images associated with a path through a physical space. The computer-implemented method can comprise determining, by the computing system, based on the image data, a plurality of scan nodes associated with the path. The plurality of scan nodes can comprise locations at which to capture a plurality of two-dimensional scanned images of the physical space. The computer-implemented method can comprise generating, by the computing system, based on the plurality of scan nodes, a plurality of instructions associated with capturing the plurality of two-dimensional scanned images of the physical space. The computer-implemented method can comprise generating, by the computing system, based on the plurality of instructions, the plurality of two-dimensional scanned images associated with the plurality of scan nodes. The computer-implemented method can comprise generating, by the computing system, based on the image data and the plurality of two-dimensional scanned images, a reconstructed three-dimensional representation of the physical space.

Another example aspect of the present disclosure is directed to one or more tangible non-transitory computer-readable media storing computer-readable instructions that when executed by one or more processors cause the one or more processors to perform operations. The operations can comprise receiving image data comprising a plurality of two-dimensional images associated with a path through a physical space. The operations can comprise determining, based on the image data, a plurality of scan nodes associated with the path. The plurality of scan nodes can comprise locations at which to capture a plurality of two-dimensional scanned images of the physical space. The operations can comprise generating, based on the plurality of scan nodes, a plurality of instructions associated with capturing the plurality of two-dimensional scanned images of the physical space. The operations can comprise generating, based on the plurality of instructions, the plurality of two-dimensional scanned images associated with the plurality of scan nodes. Furthermore, the operations can comprise generating, based on the image data and the plurality of two-dimensional scanned images, a reconstructed three-dimensional representation of the physical space.

Another example aspect of the present disclosure is directed to a computing system comprising: one or more processors; one or more non-transitory computer-readable media storing instructions that when executed by the one or more processors cause the one or more processors to perform operations. The operations can comprise receiving image data comprising a plurality of two-dimensional images associated with a path through a physical space. The operations can comprise determining, based on the image data, a plurality of scan nodes associated with the path. The plurality of scan nodes can comprise locations at which to capture a plurality of two-dimensional scanned images of the physical space. The operations can comprise generating, based on the plurality of scan nodes, a plurality of instructions associated with capturing the plurality of two-dimensional scanned images of the physical space. The operations can comprise generating, based on the plurality of instructions, the plurality of two-dimensional scanned images associated with the plurality of scan nodes. Furthermore, the operations can comprise generating, based on the image data and the plurality of two-dimensional scanned images, a reconstructed three-dimensional representation of the physical space.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that can generate reconstructed three-dimensional representations according to example embodiments of the present disclosure;

FIG. 1B depicts a block diagram of an example computing device that can generate reconstructed three-dimensional representations according to example embodiments of the present disclosure;

FIG. 1C depicts a block diagram of an example computing device that can generate reconstructed three-dimensional representations according to example embodiments of the present disclosure;

FIG. 2 depicts a block diagram of examples of machine-learned models according to example embodiments of the present disclosure;

FIG. 3 depicts an example of a computing device according to example embodiments of the present disclosure;

FIG. 4 depicts an example of determining scan nodes according to example embodiments of the present disclosure;

FIG. 5 depicts an example of determining scan nodes according to example embodiments of the present disclosure;

FIG. 6 depicts an example of different types of paths according to example embodiments of the present disclosure;

FIG. 7 depicts an example of capturing scanned images of a physical space according to example embodiments of the present disclosure;

FIG. 8 depicts an example of interfaces for capturing scanned images of a physical space and mitigating camera blur according to example embodiments of the present disclosure;

FIG. 9 depicts an example of a computing device generating an interface for mitigating scanned image capture interruptions according to example embodiments of the present disclosure;

FIG. 10 depicts an example of interfaces for generating reconstructed three-dimensional representations according to example embodiments of the present disclosure;

FIG. 11 depicts a flow chart diagram of an example method of generating reconstructed three-dimensional representations according to example embodiments of the present disclosure;

FIG. 12 depicts a flow chart diagram of an example method of determining predicted dimensions of a physical space and scan node locations according to example embodiments of the present disclosure; and

FIG. 13 depicts a flow chart diagram of an example method of generating scanned images according to example embodiments of the present disclosure.

Reference numerals that are repeated across plural figures are intended to identify the same features in various implementations.

### DETAILED DESCRIPTION

In general, the present disclosure is directed to generating reconstructed three-dimensional representations based on two-dimensional scanned images captured from scan nodes that are determined based on features of a physical space. In particular, the disclosed technology can determine scan nodes comprising locations within a physical space from which to capture scanned images (e.g., two-dimensional scanned images) that can be used to generate a reconstructed three-dimensional representation of the physical space. Further, the scan nodes can be associated with instructions that can be used to direct the movement of an image capture device that is used to capture the scanned images. Additionally, the disclosed technology can generate reconstructed three-dimensional representations of a physical space by using techniques that can include Gaussian splatting and/or implementing machine-learned models that can include neural radiance field (NeRF) models.

The disclosed technology can include a computing system that receives image data that can comprise a plurality of two-dimensional images associated with a path through a physical space (e.g., a three-dimensional physical space). For example, the image data can comprise images of the interior of the main dining room of a restaurant that were captured using a camera that followed a path (e.g., a circuit) around the perimeter of the main dining room of the restaurant. Based on the image data, the computing system can then determine a plurality of scan nodes associated with the path. The plurality of scan nodes can comprise locations within the physical space from which to capture a plurality of scanned images (e.g., two-dimensional scanned images) of the physical space. For example, based on inputting the image data into a machine-learned model that is configured and/or trained to determine scan nodes based on input comprising image data, the computing system can generate the plurality of scan nodes. Further, in some embodiments, the computing system can process the image data and determine the scan nodes based on the performance of object detection, object classification, and/or object recognition techniques and/or operations. In particular, visual features of the images can be processed such that objects within the physical space are detected and/or recognized. Further, processing the image data can be used to determine boundaries (e.g., walls, floor, and/or ceiling) of the physical space. The location of scan nodes can then be determined based on the dimensions of the physical space and the locations of objects within the physical space.

A computing system can then generate, based on the plurality of scan nodes, a plurality of instructions associated with capturing the plurality of scanned images of the physical space. For example, the computing system can generate instructions that indicate the directions to direct an image capture device that is used to capture scanned images of the physical space. Further, based on the plurality of instructions, a computing system can generate the plurality of scanned images associated with the plurality of scan nodes. For example, the computing system can capture and/or direct the capture of the plurality of scanned images of the physical space based on the instructions. In some embodiments, the plurality of instructions can comprise instructions that control the operation of an image capture device (e.g., a camera) that is used to capture the plurality of scanned images. Further, the plurality of instructions can be provided in the form of indications (e.g., text and/or symbols such as directional arrows) that can be displayed via an interface that is used to guide the capture of the plurality of scanned images.

The computing system can then generate, based on the image data and the plurality of scanned images, a reconstructed three-dimensional representation of the physical space. The reconstructed three-dimensional representation of the physical space can comprise a three-dimensional model of the physical space that comprises reconstructed views of the physical space. For example, the computing system can generate the reconstructed three-dimensional representation based on the performance of Gaussian splatting techniques and/or Gaussian splatting operations on the plurality of two-dimensional images and the plurality of scanned images. In some embodiments, the computing system can implement one or more machine-learned models that can include a neural radiance field model that can generate the reconstructed three-dimensional representation of the physical space based on input comprising the image data and/or the plurality of scanned images.

Accordingly, the disclosed technology can automatically generate reconstructed three-dimensional representations that can be used in a variety of applications including augmented reality applications (e.g., an augmented reality application in which a reconstructed three-dimensional representation can be used to provide interior views of a location). In particular, the disclosed technology can be used to capture scanned images (e.g., two-dimensional scanned images) and/or guide the capture of scanned images that can be used to generate more accurate reconstructed three-dimensional representations that can be used in a variety of applications. For example, map and/or navigation applications can use reconstructed three-dimensional representations to provide improved views of locations that can include interior locations (e.g., rooms inside buildings). Further, the disclosed technology can assist a user in more effectively and/or safely performing the technical task of generating reconstructed three-dimensional representations by means of a continued and/or guided human-machine interaction process in which images associated with a physical space can be processed and instructions to capture scanned images to generate the reconstructed three-dimensional representations can be generated. For example, instructions directing the capture of scanned images can be provided in real-time, thereby improving the scanned images that are provided as input to generate the reconstructed three-dimensional representation.

The disclosed technology can be implemented in a computing system (e.g., a reconstructed representation generation computing system) that is configured to access data and/or perform operations on the data. For example, the operations performed by the computing system can comprise receiving image data comprising a plurality of two-dimensional images associated with a path through a physical space (e.g., a three-dimensional physical space), determining a plurality of scan nodes associated with the path, generating a plurality of instructions associated with capturing a plurality of scanned images of the physical space, generating, the plurality of scanned images, and/or generating a reconstructed three-dimensional representation of the physical space. Further, the computing system can leverage one or more machine-learned models that have been configured and/or trained to process (e.g., generate a reconstructed three-dimensional representation) input comprising image data, scan node data, and/or reconstructed representation data.

The computing system can be included as part of a system that includes a server computing device that receives data (e.g., image data) from a user's client computing device, performs operations based on the data and sends output comprising image data, scan node data, and/or reconstructed representation data back to the client computing device. In some embodiments, the computing system can include specialized hardware and/or software that enables the performance of operations specific to the disclosed technology. For example, the computing system can include one or more application specific integrated circuits and/or neural processing units that are configured to perform operations comprising receiving image data comprising a plurality of two-dimensional images associated with a path through a physical space, determining a plurality of scan nodes associated with the path, generating a plurality of instructions associated with capturing a plurality of scanned images of the physical space, generating, the plurality of scanned images, and/or generating a reconstructed three-dimensional representation of the physical space.

The computing system can generate image data. The image data can comprise a plurality of images (e.g., a plurality of path images) of a physical space. Further, the image data can comprise a plurality of two-dimensional images (e.g., a plurality of two-dimensional path images). The plurality of two-dimensional images can be associated with a path (e.g., a path through a physical space). Generation of the image data can be based on the capture of a plurality of images of a physical space by one or more image capture devices (e.g., one or more cameras). Generation of the image data can be based on one or more directions to traverse a path through a physical space (e.g., a three-dimensional physical space). Further, the image data can comprise a plurality of images captured from one or more locations within a physical space and/or one or more viewpoints within a physical space (e.g., different camera angles). For example, the image data can comprise a plurality of images associated with the traversal of a path through a physical space (e.g., a plurality of images captured from one or more different locations within the main hall of an auditorium and/or one or more different viewpoints of the main hall of an auditorium).

In some embodiments, the plurality of two-dimensional images associated with a path (e.g., a plurality of two-dimensional images captured while traversing a path) can be different from a plurality of scanned images (e.g., a plurality of two-dimensional scanned images) associated with a plurality of scan nodes (e.g., a plurality of two-dimensional images captured from a plurality of scan nodes) and/or mutually exclusive with respect to a plurality of scanned images associated with a plurality of scan nodes. Further, in some embodiments, the plurality of scanned images (e.g., the plurality of two-dimensional scanned images associated with a plurality of scan nodes) can include one or more images of the plurality of two-dimensional images.

The image data can comprise a plurality of color images, a plurality of grayscale images, and/or a plurality of black and white images. In some embodiments, the images of the image data can be formatted to have the same or similar resolution and/or color depth. In some embodiments, images of the image data can include a plurality of points (e.g., pixels) that indicate visual information about a portion (e.g., x, y coordinates of a two-dimensional image or x, y, z coordinates of a three-dimensional image) of the plurality of images. Further, the plurality of images can comprise information associated with visual features of the plurality of images including spatial features associated with the spatial relations between groups of the plurality of points (e.g., spatial relations between lines and/or curves in an image). Further, the plurality of images can comprise information associated with a color space of the plurality of points (e.g., a hue, saturation, and/or brightness). In some embodiments, a geographic location (e.g., latitude, longitude, and/or elevation) can be associated with each of the plurality of images of the image data.

The computing system can determine a path through the physical space (e.g., the three-dimensional physical space). Determination of the path through the physical space can be based on image data. The computing system can determine a path through the physical space based on processing the image data associated with the locations at which each of the plurality of images was captured. The computing system can use the image data to perform one or more object detection, object recognition, and/or object classification to determine the visual features of the physical space. For example, the computing system can perform object detection, object recognition, and/or object classification operations to determine the locations of walls, doors (e.g., entrances and/or exits), windows, and/or furniture within a physical space.

Further, the computing system can determine estimated dimensions and an estimated shape of the physical space. Based on the visual features of the physical space, the computing system can determine a path through the physical space. For example, the computing system can determine and/or generate a path that follows a circuit around the perimeter of the physical space based on the locations of walls of the physical space. By way of further example, the computing system can determine and/or generate a path that passes through the approximate center of a physical space and/or edges (e.g., the corners of a room) of a physical space. Further, the computing system can determine a path through the physical space based on one or more criteria (e.g., one or more path criteria) which can comprise determining a path that is a circuit (e.g., the path starts and ends at the same location), determining a path that starts and/or ends at an entrance and/or exit of a physical space, determining a path that enables the capture of images that cover a threshold portion of the physical space, determining location in which objects do not obstruct the capture of images from a scan node, and/or determining locations in which captured images are less likely to be occluded.

In some embodiments, the computing system can determine a path through the physical space (e.g., the three-dimensional physical space) based on inputting the plurality of images of the image data into one or more machine-learned models that are configured and/or trained to determine a path through the three-dimensional space based on the image data. For example, the one or more machine-learned models can be configured and/or trained to determine a path through the physical space that avoids obstructions (e.g., a location of the physical space that is occupied by a pillar or fountain) and/or locations from which capture of scanned images of the three-dimensional physical space is occluded.

In some embodiments, the path can comprise a predetermined path through the physical space that can be processed by the computing system. For example, the path can comprise information indicating the locations and/or relative positions of the plurality of images of the image data. Further, the predetermined path can be based on traversal of a physical space (e.g., a walkthrough of a portion of a physical space by an image capture device operator and/or a fly through of a portion of a physical space by an autonomous aerial vehicle) in which the path is based on and/or comprises the locations of the physical space that were traversed.

The computing system can receive, access, and/or retrieve image data. The image data can comprise a plurality of images. For example, the plurality of images can comprise a plurality of two-dimensional images. The plurality of images (e.g., plurality of two-dimensional images) can be associated with the path through a physical space. For example, the computing system can receive image data from another computing system (e.g., a remote computing system) and/or retrieve the image data from a local storage device on which the image data is stored.

The computing system can determine a plurality of scan nodes. The plurality of scan nodes can be associated with the path. Further, the plurality of scan nodes can be based on the image data. The plurality of scan nodes can comprise locations at which to capture a plurality of scanned images (e.g., a plurality of two-dimensional scanned images) of the physical space. Further, the plurality of scan nodes can be associated with and/or comprise locations within the physical space from which images. For example, the plurality of scan nodes can be associated with and/or comprise locations within the physical space from which scanned images captured by an image capture device can be captured.

Determining the plurality of scan nodes (e.g., the plurality of scan nodes associated with the path) can comprise determining estimated dimensions of the physical space. Further, determining the estimated dimensions of the physical space can be based on the image data space. For example, the computing system can perform one or more operations to detect, recognize, and/or classify one or more features of the plurality of images of the image data. Based on processing the image data, the computing system can recognize objects in the physical space (e.g., objects comprising doors, windows, floors, ceilings, and/or furniture). Based on the recognition of the objects, the computing system can determine spatial relations between the objects and determine estimated dimensions of the physical space based on the spatial relations between objects.

Further, determining the estimated dimensions of the physical space can be based on inputting the image data into one or more machine-learned models that are configured to determine three-dimensional features based on detection of two-dimensional features of the two-dimensional images. For example, the image data can be inputted into one or more machine-learned models that are configured and/or trained to output estimated dimensions of physical spaces based on recognizing objects in an image. Further, the one or more machine-learned models can use the dimensions of previously recognized reference objects that match the recognized objects to determine estimated dimensions of the physical space within which the recognized object is present.

Determining the plurality of scan nodes associated with the path can comprise determining, based on the image data, the plurality of scan nodes comprising locations from which a field of view to capture the plurality of scanned images is not occluded by one or more objects. The computing system can determine the locations of objects in the plurality of images. Further, the computing system can determine locations from which the plurality of objects may not occlude a field of view of an image capture device associated with a scan node. For example, the computing device can determine the location of objects comprising tables, pillars, and/or large furniture that can block the field of view of an image capture device (e.g., a camera). In some embodiments, one or more machine-learned models can be configured and/or trained to determine, based on input comprising the image data, the plurality of scan nodes comprising locations from which a field of view to capture the plurality of scanned images is not occluded by one or more objects.

Determining the plurality of scan nodes associated with the path can comprise determining the plurality of scan nodes comprising locations from which capture of the plurality of scanned images is not obstructed by one or more objects. Determining the plurality of scan nodes comprising locations from which capture of the plurality of scanned images is not obstructed by one or more objects can be based on the image data. Further, the computing system can perform one or more object detection and/or object recognition operations to determine the location of one or more objects (e.g., furniture) within a physical space. The computing system can then determine that the plurality of scan nodes may not be located in locations that are occupied and/or obstructed by the one or more objects. For example, the computing system can determine that a scan node may not be located on top of a dinner table, under a chair, and/or in the middle of a fountain.

In some embodiments, the location of the plurality of scan nodes can be constrained based on one or more height thresholds that can comprise a maximum height threshold (e.g., a scan node and/or an image capture device associated with a scan node may not be positioned at a height of more than three meters high above a ground surface which can include a floor surface) and/or a minimum height threshold (e.g., a scan node and/or an image capture device associated with a scan node may not be positioned at a height of less than half a meter above a ground surface). Further, the height of the plurality of scan nodes can be determined to be within a height range (e.g., the plurality of scan nodes and/or an image capture device associated with a scan node may be positioned at a height in the range of one meter above a ground surface to two meters above a ground surface).

The computing system can generate a plurality of instructions associated with capturing the plurality of scanned images of the physical space. Generating the plurality of instructions can be based on the plurality of scan nodes. The plurality of instructions can comprise one or more text-based instructions (e.g., text-based instructions to position an image capture device at a certain height, direction, or angle), one or more audio-based instructions (e.g., a synthetic voice that indicates that an image capture device is located in or near a scan node), and/or one or more visual indications (directional arrows to indicate a direction to move an image capture device to capture the plurality of scanned images of a physical space). For example, the computing system can generate, within an augmented reality interface (e.g., an augmented reality interface generated on a smartphone and/or an augmented reality headset) a sphere (e.g., a semi-opaque sphere that is a light green color or tint and shows a light green colored version of the physical space) around an image capture device and instructions to move the image capture device such that scanned images of the physical space are captured. The portions of the physical space that are captured by the image capture device can be indicated in the sphere by the sphere becoming transparent (e.g., changing from a light green color to become transparent without the light green tint) in the portions corresponding to portions of the physical space for which the plurality of scanned images of the physical space have been captured. The plurality of instructions can comprise instructions to indicate placement of an image capture device in or near a scan node, instructions to position an image capture device at a certain height, in a certain direction, and/or at a certain angle. Further, the plurality of instructions can comprise instructions to locate an image capture device in or near a scan node of the plurality of scan nodes. In some embodiments, the computing system can implement one or more machine-learned models (e.g., large language models (LLMs)) that are configured and/or trained to generate a plurality of instructions that can comprise one or more natural language instructions. For example, the plurality of instructions can comprise instructions to “MOVE THE IMAGE CAPTURE DEVICE FORWARD” or “SCAN THE AREA IN THE DIRECTION OF THE CEILING.”

The plurality of instructions can comprise an instruction to capture the plurality of scanned images comprising a substantially omnidirectional field of view (e.g., a 90% omnidirectional field of view and/or a substantially omnidirectional field of view that comprises an entire top hemisphere of a spherical field of view and ninety percent of a lower hemisphere of the spherical field of view relative to a ground surface that can comprise a floor) from each of the plurality of scan nodes. For example, the plurality of instructions can direct an image capture device to be moved in a circular or spherical pattern to capture the plurality of scanned images.

The computing system can generate, based on the plurality of instructions, the plurality of scanned images (e.g., two-dimensional scanned images). Generating the plurality of scanned images can comprise capturing (e.g., capturing using an image capture device) a plurality of scanned images of a physical space. The plurality of scanned images can be associated with the plurality of scan nodes (e.g., the plurality of scanned images can be captured from the locations of the plurality of scan nodes). For example, an image capture device can detect and/or capture the plurality of scanned images. Further, the plurality of scanned images can comprise two-dimensional images and can comprise any of the features of the plurality of images of the image data. For example, the plurality of scanned images can comprise a plurality of color images, a plurality of grayscale images, and/or a plurality of black and white images. In some embodiments, the plurality of scanned images can be formatted to have the same or similar resolution and/or color depth. In some embodiments, plurality of scanned images can include a plurality of points (e.g., pixels) that indicate visual information about a portion (e.g., x, y coordinates of a two-dimensional image or x, y, z coordinates of a three-dimensional image) of the plurality of images.

The plurality of scanned images can comprise images that cover any portion of an omnidirectional or substantially omnidirectional field of view relative to each of the plurality of scan nodes. For example, the plurality of scanned images of a physical space comprising a cube shaped room can comprise images of the four walls, ceiling, and floor of the cube shaped room. Further, the plurality of scanned images of a physical space comprising a cube shaped room can comprise images of the corners (e.g., eight corners) of the cube shaped room. In some embodiments, the plurality of scanned images can comprise images captured from various heights including heights that can approximate the eye level of a viewer standing on a floor of a physical space (e.g., at a height in the range of 1.1 meters high to 2.1 meters high).

Further, the plurality of scanned images can comprise information associated with visual features including spatial features associated with the spatial relations between groups of the plurality of points (e.g., spatial relations between lines and/or curves in a scanned image). Further, the plurality of scanned images can comprise information associated with a color space of the plurality of points (e.g., a hue, saturation, and/or brightness). In some embodiments, a geographic location (e.g., latitude, longitude, and/or altitude) can be associated with each of the plurality of scanned images of the image data. Further, the geographic location can be used to determine the locations of the plurality of scan nodes.

The plurality of scanned images can be captured by one or more sensors that can comprise one or more image capture devices. The one or more image capture devices can comprise one or more cameras. Further, the one or more image capture devices can comprise a smartphone and/or an extended reality device (e.g., an augmented reality headset).

Generating the plurality of scanned images associated with the plurality of scan nodes can comprise determining that a velocity of the image capture device does not exceed a scanned image capture velocity threshold. The scanned image capture velocity threshold can be based on a velocity of the image capture device that allows for the image capture device to capture a plurality of scanned images that are suitable for use in generating the reconstructed three-dimensional representation (e.g., the plurality of scanned images are not incomplete, underexposed, overexposed, and/or blurry). For example, an image capture device can comprise one or more sensors (e.g., one or more image sensors, one or more accelerometers, and/or one or more gyroscopes) can be used to determine the velocity and/or acceleration of the image capture device and whether the image capture device is moving at a velocity that exceeds the scanned image capture velocity threshold. In some embodiments, based on the image capture device exceeding the scanned image capture velocity threshold, the computing system can generate an indication that the image capture device has exceeded the scanned image capture velocity threshold (e.g., an indication indicating “THE IMAGE CAPTURE DEVICE IS MOVING TO QUICKLY, PLEASE SLOW THE VELOCITY OF THE IMAGE CAPTURE DEVICE.”). In some embodiments, if the scanned image capture velocity threshold is exceeded by the image capture device, the plurality of scanned images that were captured when the scanned image capture velocity threshold was exceeded can be captured again (e.g., captured again at a velocity of the image capture device that does not exceed the scanned image capture velocity threshold).

In some embodiments, the scanned image capture velocity threshold can comprise a predetermined velocity that is based on the image capture device and/or a configuration of the image capture device (e.g., a configuration of an image capture device comprising shutter speed settings and/or light sensitivity settings). For example, an image capture device can be associated with a scanned image capture velocity threshold based on the image capture capabilities of the image capture device.

In some embodiments, the scanned image capture velocity threshold can be modified based on the configuration of the image capture device. For example, the shutter speed of an image capture device can be positively correlated with the scanned image capture velocity threshold such that a higher shutter speed can be associated with a higher scanned image capture velocity threshold. Further, the light sensitivity (e.g., ISO) of an image capture device can be negatively correlated with the scanned image capture velocity threshold such that a higher light sensitivity can be associated with a lower scanned image capture velocity threshold.

Generating the plurality of scanned images associated with the plurality of scan nodes can comprise determining that an image capture rate of the image capture device does not exceed a scanned image capture rate threshold. The scanned image capture rate threshold can be based on an image capture rate of the image capture device that allows for the image capture device to capture a plurality of scanned images that are suitable for use in generating the reconstructed three-dimensional representation (e.g., the plurality of scanned images are not incomplete or blurred). For example, an image capture device can determine whether the capacity of the image capture device's image storage buffer has been exceeded and/or the image captures device's sensor (e.g., optical sensor) capture rate has been exceeded. In some embodiments, based on the image capture device exceeding the scanned image capture rate threshold, the computing system can generate an indication that the image capture device has exceeded the scanned image capture rate threshold (e.g., an indication indicating “THE IMAGE CAPTURE DEVICE IS UNABLE TO CAPTURE THE SCANNED IMAGES, PLEASE PAUSE CAPTURE OF THE SCANNED IMAGES.”). In some embodiments, if the scanned image capture rate threshold is exceeded by the image capture device, the plurality of scanned images that were captured when the scanned image capture rate threshold was exceeded can be captured again (e.g., captured again at image capture rate of the image capture device that does not exceed the scanned image capture rate threshold).

Generating the plurality of scanned images associated with the plurality of scan nodes can comprise determining one or more directions in which to position the image capture device to capture the plurality of scanned images. The computing system can determine one or more directions (e.g., directions in which to point an image capture device) in which to point an image capture device to capture the plurality of scanned images of the physical space around a scan node. Further, the computing system can determine one or more directions (e.g., directions in which an image capture device is pointed) from which the plurality of scanned images have been captured. The computing system can then determine one or more directions to point the image capture device to capture the remaining plurality of scanned images.

Generating the plurality of scanned images associated with the plurality of scan nodes can comprise determining a portion of a predetermined field of view of the physical space from each of the plurality of scan nodes that has been captured. For example, the computing system can monitor the state of an image capture device (e.g., the orientation and/or position of an image capture device). Further, the computing system can monitor and/or determine the plurality of scanned images that have been captured at each of the orientations and/or positions of the image capture device from each of the plurality of scan nodes. Based on the positions of the image capture device, the portions of the predetermined field of view for which the plurality of scanned images of the physical space have been captured can be determined. In some embodiments, one or more sensors (e.g., one or more gyroscopes and/or one or more accelerometers) that detect the position and/or movement of an image capture device used to capture the plurality of scanned images can be used to determine whether a predetermined field of view (e.g., a substantially omnidirectional and/or substantially three-hundred and sixty degree field of view around a scan node) has been captured.

Generating the plurality of scanned images associated with the plurality of scan nodes can comprise generating one or more indications of the portion of the predetermined field of view of the physical space from each of the plurality of scan nodes that has been captured. The computing system can generate an indication of the percentage of the predetermined field of view of the physical space that has been captured. Further, the computing system can generate a status bar that can increase in size and/or change color based on the portion of the predetermined field of view of the physical space from each of the plurality of scan nodes that has been captured.

Generating, based on the plurality of instructions, the plurality of scanned images associated with the plurality of scan nodes can comprise determining whether a threshold portion of a predetermined field of view of the physical space from each of the plurality of scan nodes has been captured. For example, the computing system can determine the plurality of scanned images that have been captured and thereby determine the portion of the physical space for which the plurality of scanned images have been captured. In some embodiments, one or more sensors (e.g., one or more gyroscopes and/or one or more accelerometers) that detect the position and/or movement of an image capture device used to capture the plurality of scanned images can be used to determine whether a predetermined field of view has been captured.

Based on a determination that the threshold portion of the predetermined field of view (e.g., omnidirectional field of view) being captured, the computing system can generate one or more indications that scanning associated with the plurality of nodes is complete. For example, based on the computing system determining that scanning (e.g., capture of the plurality of scanned images) of a physical space associated with a scan node is complete a visual indication (e.g., a text notification that scanning is complete and/or a symbol of a checkmark or thumbs image) can be generated. In some embodiments, one or more audio indications (e.g., a chime, musical tone, or synthetic speech announcing “SCAN COMPLETE”) can be generated to indicate that scanning is complete.

The computing system can generate, based on the image data and the plurality of scanned images, a reconstructed three-dimensional representation of the physical space. Further, the computing system can perform one or more operations to generate a reconstructed three-dimensional representation based on the detection, recognition, and/or classification of visual features and/or objects associated with the image data and/or the plurality of scanned images. The reconstructed three-dimensional representation can comprise a three-dimensional model associated with the physical space. Further, the reconstructed three-dimensional representation can comprise a plurality of points and each of the plurality of points can be associated with a set of coordinates (e.g., x coordinates, y coordinates, and z coordinates associated with the position of each of the plurality of points in a three-dimensional space). Further, each of the plurality of points of the reconstructed three-dimensional representation can be associated with a color and/or color space (e.g., a YUV color space comprising a luma component and two chroma components). In some embodiments, the reconstructed three-dimensional representation can comprise a vector based model.

The reconstructed three-dimensional representation can be based on performance of one or more Gaussian splatting techniques and/or one or more Gaussian splatting operations on the image data (e.g., the plurality of two-dimensional images) and/or the plurality of scanned images. Further, generating the reconstructed three-dimensional representation based on performance of the one or more Gaussian splatting techniques and/or one or more Gaussian splatting operations on the image data and/or the plurality of scanned images can comprise determining a plurality of Gaussian points of a point cloud associated with the points (e.g., pixels) of images in the image data and/or the plurality of scanned images. Further, the reconstructed three-dimensional representation can be based on projecting the plurality of Gaussian points onto an image plane associated with the plurality of images (e.g., the images of the image data and/or the plurality of scanned images).

In some embodiments, an estimated depth associated with each point (e.g., each pixel) in images of one or more objects (e.g., one or more objects captured from different perspectives) can be determined. For example, an estimated depth of points (e.g., pixels) of a plurality of images of a chair captured from different angles can be estimated. The estimated depth of the points in an image can be used to generate the reconstructed three-dimensional representation.

The reconstructed three-dimensional representation can be based on inputting the image data and the plurality of scanned images into one or more machine-learned models configured to generate the reconstructed three-dimensional representation. For example, the computing system can implement one or more machine-learned models that are configured and/or trained to generate the reconstructed three-dimensional representation based on input comprising the image data and/or the plurality of scanned images. For example, a plurality of scanned images of an exhibition room of an art gallery can be inputted into the one or more machine-learned models which can generate a reconstructed three-dimensional representation of the exhibition room of the art gallery. In some embodiments, the one or more machine-learned models can be configured and/or trained to perform one or more Gaussian splatting techniques and/or one or more Gaussian splatting operations to generate the reconstructed three-dimensional representation of a physical space.

The one or more machine-learned models can comprise one or more neural radiance field (NeRF) models. For example, the computing system can implement one or more NeRF models that are configured and/or trained to generate the reconstructed three-dimensional representation based on input comprising the image data and/or the plurality of scanned images. The one or more machine-learned models comprising one or more NeRF models can map three-dimensional spatial features (e.g., x, y, and z coordinates associated with a physical space) and viewing direction to color values and the volume density of an image. For example, the one or more machine-learned models comprising one or more NeRF models can receive image data comprising a plurality of images captured from various locations along the nave of a cathedral. The one or more machine-learned models comprising one or more NeRF models can then generate a reconstructed three-dimensional representation in which the portions of the cathedral captured in the plurality of images are represented.

The computing system can generate an extended reality environment (e.g., an augmented reality environment, a virtual reality environment, and/or a mixed reality environment) based on the reconstructed three-dimensional representation. Further, the computing system can implement an augmented reality application that is configured to generate an augmented reality environment based on the reconstructed three-dimensional representation. For example, the computing system can generate an augmented reality environment comprising a reconstructed three-dimensional representation based on a plurality of scanned images of a public display area of a museum. Further, the augmented reality environment can be generated and/or displayed via a smartphone display and/or an augmented reality headset.

In some embodiments, one or more machine-learned models can be configured and/or trained to predict dimensions of a physical space, determine a path through a physical space, determine a plurality of scan nodes, determine instructions associated with capturing a plurality of scanned images of a physical space, and/or generate a reconstructed three-dimensional representation of a physical space. The one or more machine-learned models can be configured and/or trained to predict dimensions of a physical space based on detection of visual features of images (e.g., two-dimensional images in image data), recognition of objects in images, and/or classification of objects in images.

The one or more machine-learned models can be configured and/or trained to determine a plurality of scan nodes based on detection of visual features of images (e.g., two-dimensional images in image data), recognition of objects in images, and/or classification of objects in images. For example, scan nodes can be determined based on the detection of objects such that a scan node is located in a location of a physical space in which a viewpoint is not occluded and the scan node is not obstructed. The one or more machine-learned models can comprise a NeRF model that can be configured and/or trained to generate a reconstructed three-dimensional representation of a physical space based on mapping three-dimensional spatial coordinates and directions to color and density values extracted from two-dimensional images (e.g., two-dimensional images of the physical space).

The one or more machine-learned models can be trained using training data. Further, as part of training the one or more machine-learned models the computing system can receive training data. The training data can comprise training image data that can comprise a plurality of training images (e.g., two-dimensional training images), a plurality of scanned training images, a plurality of training physical spaces, a corresponding plurality of ground-truth physical spaces, a corresponding plurality of ground-truth scan nodes, a corresponding plurality of ground-truth instructions, and/or a corresponding plurality of ground-truth reconstructed three-dimensional representations.

In some embodiments, the training data can comprise a plurality of embeddings. The plurality of embeddings can comprise a lower-dimensionality vector space representation of the training data. For example, the plurality of training images can be represented in a lower-dimensional vector space that can preserve information about the plurality of training images in a smaller dimensional vector space than the higher-dimensional vector space of the original plurality of training images (e.g., a high-dimensional vector space that can include information about every pixel of the training images). The plurality of embeddings can be arranged such that semantically similar embeddings are closer together in the vector space.

Training the one or more machine-learned models can comprise generating and/or determining, based on inputting the training data into the one or more machine-learned models, a plurality of predicted scan nodes. Based on the received input which can comprise the training image data, the one or more machine-learned models can perform one or more operations and generate an output comprising a plurality of predicted scan nodes associated with the corresponding plurality of training image data. The output of the one or more machine-learned models can then be evaluated based on one or more comparisons of the plurality of predicted scan nodes to a corresponding plurality of ground-truth scan nodes associated with the training data (e.g., ground-truth scan nodes based on the same training image data as the predicted scan nodes).

Training the one or more machine-learned models can comprise determining a loss based on one or more differences between the plurality of predicted scan nodes and the plurality of ground-truth scan nodes. A loss function can be used to determine the loss. Further, the loss function can be used to evaluate one or more differences between the plurality of predicted scan nodes and the plurality of ground-truth scan nodes. The loss can increase in proportion to the number of the one or more differences between the plurality of predicted scan nodes and the plurality of ground-truth scan nodes. For example, if a plurality of predicted scan nodes and the corresponding plurality of ground-truth scan nodes comprise a very different number of scan nodes and/or very different locations of scan nodes, the loss can be greater than if the predicted scan nodes have a very similar number of scan nodes and/or very similar locations of the scan nodes from the corresponding plurality of ground-truth scan nodes.

Training the one or more machine-learned models can comprise modifying a plurality of parameters of the one or more machine-learned models to minimize the loss. The plurality of parameters can be associated with detection, recognition, and/or classification of one or more features of the training data that can be used to determine the plurality of predicted scan nodes. For example, the plurality of parameters can be associated with detection of surfaces (e.g., walls, floors, and/or ceilings) and/or other objects (e.g., furniture) in images. Further, the plurality of parameters can be associated with a plurality of weights that can be associated with an extent to which the plurality of parameters contribute to determining the loss.

Training the one or more machine-learned models can be performed over a plurality of iterations. In each iteration of training, the weight of the plurality of parameters that contribute to increasing the loss can be reduced and/or the weight of the plurality of parameters that contribute to decreasing the loss can be increased. As a result, the plurality of weights of the plurality of parameters can be associated with the plurality of predicted scan nodes such that parameters that are more heavily weighted can contribute more to determining the predicted scan nodes than parameters that are less heavily weighted. Over the plurality of iterations, the weights of the plurality of parameters can be modified to minimize the loss until a threshold loss that corresponds to a high accuracy of the one or more machine-learned models determining the plurality of predicted scan nodes is achieved. For example, the loss can be minimized until a threshold loss associated with 98% accuracy is achieved by the machine-learned model.

Training the one or more machine-learned models can comprise generating and/or determining, based on inputting the training data into the one or more machine-learned models, a plurality of predicted dimensions of the physical space. Based on the received input which can comprise the training image data, the one or more machine-learned models can perform one or more operations and generate an output comprising a plurality of predicted dimensions of the physical space associated with the corresponding plurality of training image data. The output of the one or more machine-learned models can then be evaluated based on one or more comparisons of the plurality of predicted dimensions of the physical space to a corresponding plurality of ground-truth dimensions of the physical space associated with the training data (e.g., ground-truth dimensions of the physical space based on the same training image data as the predicted dimensions of the physical space).

Training the one or more machine-learned models can comprise determining a loss based on one or more differences between the plurality of predicted dimensions of the physical space and the plurality of ground-truth dimensions of the physical space. A loss function can be used to determine the loss. Further, the loss function can be used to evaluate one or more differences between the plurality of predicted dimensions of the physical space and the plurality of ground-truth dimensions of the physical space. The loss can increase in proportion to the number of the one or more differences between the plurality of predicted dimensions of the physical space and the plurality of ground-truth dimensions of the physical space. For example, if a plurality of predicted dimensions of the physical space and the corresponding plurality of ground-truth dimensions of the physical space comprise very different dimensions of the physical space (e.g., much larger or smaller dimensions or different proportions) and/or a very different shape (e.g., a square room instead of a circular room) of the physical space, the loss can be greater than if the predicted dimensions of the physical space have very similar dimensions of the physical space and/or a very similar shape of the physical space from the corresponding plurality of ground-truth dimensions of the physical space.

Training the one or more machine-learned models can comprise modifying a plurality of parameters of the one or more machine-learned models to minimize the loss. The plurality of parameters can be associated with detection, recognition, and/or classification of one or more features of the training data that can be used to determine the plurality of predicted dimensions of the physical space. For example, the plurality of parameters can be associated with detection of surfaces (e.g., walls, floors, and/or ceilings) and/or other objects (e.g., fountains, pillars, and/or furniture) in images. Further, the plurality of parameters can be associated with a plurality of weights that can be associated with an extent to which the plurality of parameters contribute to determining the loss.

Training the one or more machine-learned models can be performed over a plurality of iterations. In each iteration of training, the weight of the plurality of parameters that contribute to increasing the loss can be reduced and/or the weight of the plurality of parameters that contribute to decreasing the loss can be increased. As a result, the plurality of weights of the plurality of parameters can be associated with the plurality of predicted dimensions of the physical space such that parameters that are more heavily weighted can contribute more to determining the predicted dimensions of the physical space than parameters that are less heavily weighted. Over the plurality of iterations, the weights of the plurality of parameters can be modified to minimize the loss until a threshold loss that corresponds to a high accuracy of the one or more machine-learned models determining the plurality of predicted dimensions of the physical space is achieved. For example, the loss can be minimized until a threshold loss associated with 95% accuracy is achieved by the machine-learned model.

Training the one or more machine-learned models can comprise generating and/or determining, based on inputting the training data into the one or more machine-learned models, a plurality of predicted reconstructed three-dimensional representations. Based on the received input, which can comprise the plurality of scanned training images, the one or more machine-learned models can perform one or more operations and generate an output comprising a plurality of predicted reconstructed three-dimensional representations associated with the corresponding plurality of scanned training images. The output of the one or more machine-learned models can then be evaluated based on one or more comparisons of the plurality of predicted reconstructed three-dimensional representations to a corresponding plurality of ground-truth reconstructed three-dimensional representations associated with the training data (e.g., a plurality of ground-truth reconstructed three-dimensional representations based on the same plurality of scanned training images as the plurality of predicted reconstructed three-dimensional representations).

Training the one or more machine-learned models can comprise determining a loss based on one or more differences between the plurality of predicted reconstructed three-dimensional representations and the plurality of ground-truth reconstructed three-dimensional representations. A loss function can be used to determine the loss. Further, the loss function can be used to evaluate one or more differences between the plurality of predicted reconstructed three-dimensional representations and the plurality of ground-truth reconstructed three-dimensional representation. The loss can increase in proportion to the number of the one or more differences between the plurality of predicted reconstructed three-dimensional representations and the plurality of ground-truth reconstructed three-dimensional representations. For example, if a plurality of predicted reconstructed three-dimensional representations and the corresponding plurality of ground-truth reconstructed three-dimensional representation have very different shapes, colors, and/or dimensions, the loss can be greater than if the predicted reconstructed three-dimensional representations have very similar shapes, colors, and/or dimensions in comparison to the corresponding plurality of ground-truth reconstructed three-dimensional representations.

Training the one or more machine-learned models can comprise modifying a plurality of parameters of the one or more machine-learned models to minimize the loss. The plurality of parameters can be associated with detection, recognition, and/or classification of one or more features of the training data that can be used to determine the plurality of predicted reconstructed three-dimensional representations. For example, the plurality of parameters can be associated with detection of surfaces (e.g., walls, floors, and/or ceilings) and/or other objects (e.g., furniture) in images. Further, the plurality of parameters can be associated with a plurality of weights that can be associated with an extent to which the plurality of parameters contribute to determining the loss.

Training the one or more machine-learned models can be performed over a plurality of iterations. In each iteration of training, the weight of the plurality of parameters that contribute to increasing the loss can be reduced and/or the weight of the plurality of parameters that contribute to decreasing the loss can be increased. As a result, the plurality of weights of the plurality of parameters can be associated with the plurality of predicted reconstructed three-dimensional representations such that parameters that are more heavily weighted can contribute more to determining the plurality of predicted reconstructed three-dimensional representations than parameters that are less heavily weighted. Over the plurality of iterations, the weights of the plurality of parameters can be modified to minimize the loss until a threshold loss that corresponds to a high accuracy of the one or more machine-learned models determining the plurality of predicted reconstructed three-dimensional representations is achieved. For example, the loss can be minimized until a threshold loss associated with 99% accuracy is achieved by the machine-learned model.

The systems, methods, devices, and/or computer-readable media (e.g., tangible non-transitory computer-readable media) in the disclosed technology can provide a variety of technical effects and benefits including an improvement in the effectiveness with which reconstructed three-dimensional representations based on physical spaces can be generated. In particular, the disclosed technology can be used to determine improved locations for scan nodes from which to capture scanned images of a physical space. The disclosed technology can also improve the effectiveness with which computational resources are used by performing image processing techniques and/or image processing operations such as Gaussian splatting and/or leveraging one or more machine-learned models comprising neural radiance field (NeRF) models that are configured and/or trained to generate reconstructed three-dimensional representations.

The disclosed technology can automatically generate scan nodes from which to capture scanned images. The scan nodes can be associated with locations in a physical space that are unobstructed and from which scanned images of the physical space can be captured without occlusion. The resulting improvement in coverage of a physical three-dimensional space can reduce the incidence of missing portions in a reconstructed three-dimensional representation. This more efficient capture of scanned images can result in more efficient usage of computational resources and storage resources by reducing the need to capture additional scanned images.

Further, the disclosed technology can determine the capture rate (e.g., a rate of capturing scanned images per area of a physical space) required for adequate generation of reconstructed three-dimensional representations and guide the capture of scanned images such that the movement (e.g., velocity and/or acceleration) and/or direction of an image capture device is able to capture a sufficient number of scanned images and meet the capture rate and requirements. The more effective capture of scanned images can result in the generation of more accurate reconstructed three-dimensional representations (e.g., reconstructed three-dimensional representations that include features that more accurately reflect the state of the physical space captured by the scanned images). Additionally, controlling the movement (e.g., the velocity and/or acceleration) of image capture devices can reduce blurring that reduces the accuracy of the reconstructed three-dimensional representation and increases the use of computational resources to compensate for the blurring.

As such, the disclosed technology can allow the user of a computing system to perform the technical task of capturing scanned images of a physical space and generating reconstructed three-dimensional representations based on the physical space. As a result, users can be provided with the specific benefits of improved performance (scanned image capture performance), a reduction in image blur, an increase in coverage of the physical space, and more efficient use of computational resources and storage resources. Further, any of the specific benefits provided to users can be used to improve the effectiveness of a wide variety of devices and services including services that use reconstructed three-dimensional representations (e.g., augmented reality services). Accordingly, the improvements offered by the disclosed technology can result in tangible benefits to a variety of devices and/or systems including mechanical, electronic, and computing systems associated with capturing scanned images of a physical space and/or generating reconstructed three-dimensional representations based on the physical space.

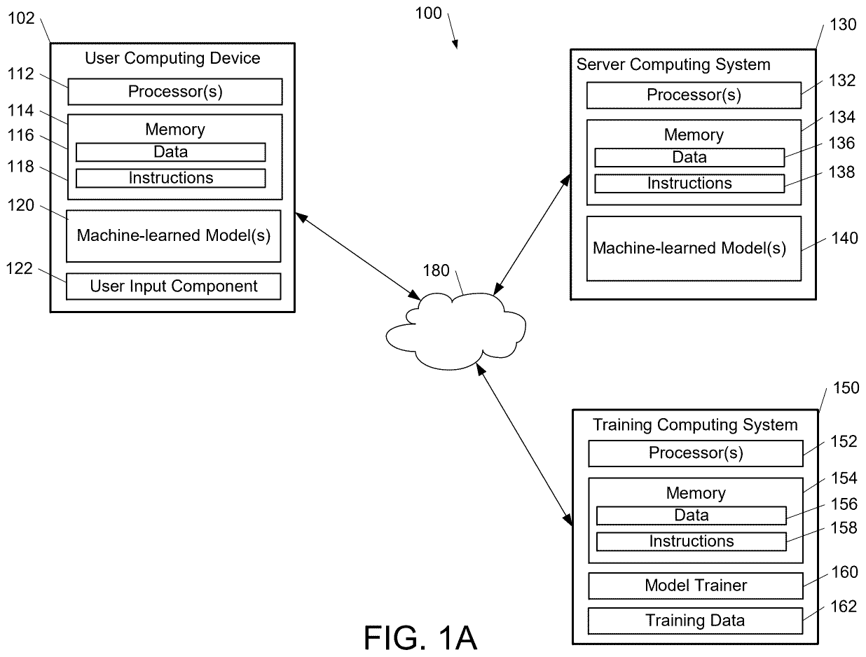

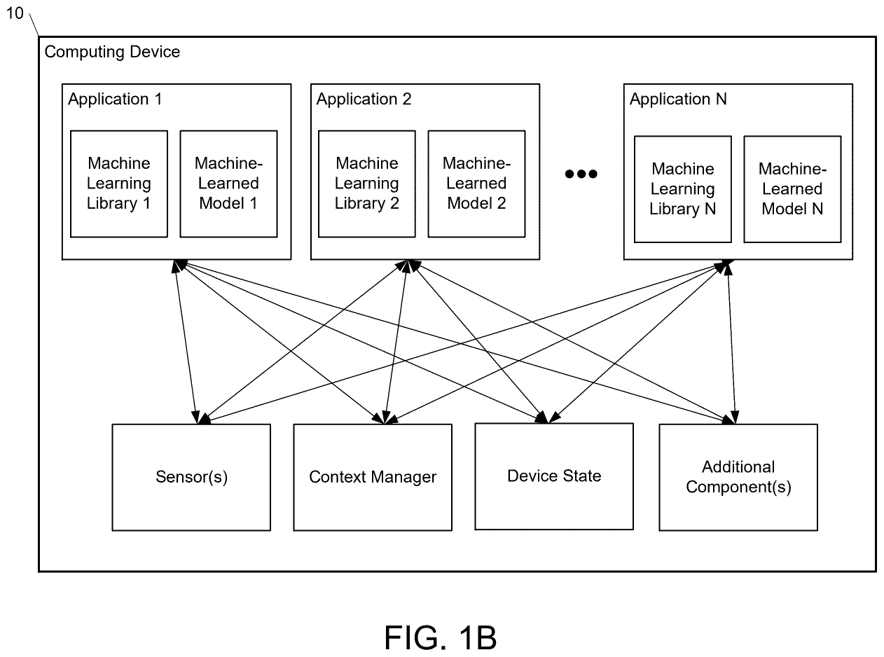

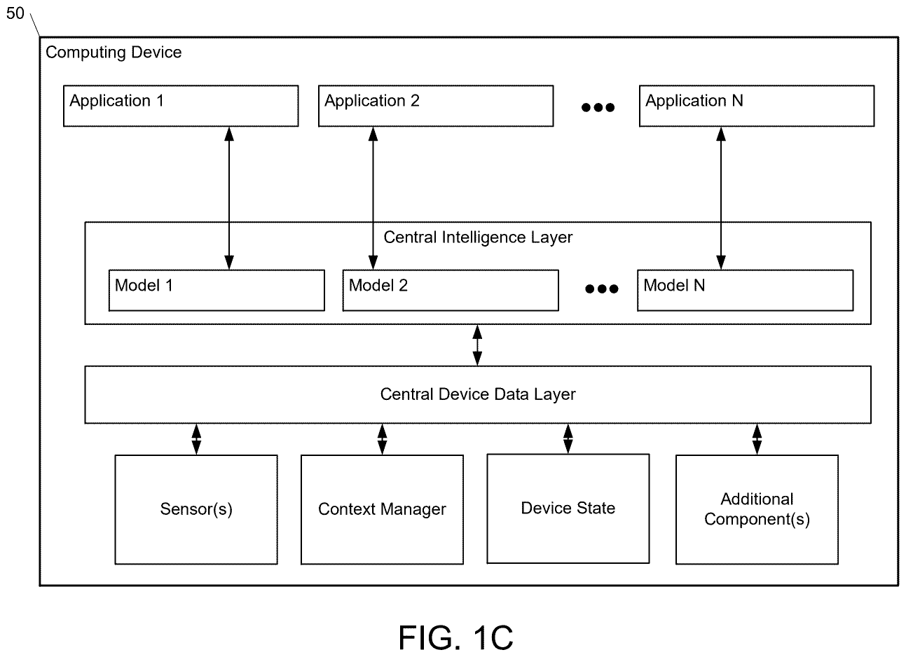

With reference now to the figures, example embodiments of the present disclosure will be discussed in further detail. FIG. 1A depicts a block diagram of an example computing system that can generate reconstructed three-dimensional representations according to example embodiments of the present disclosure. System 100 includes a computing device 102, a server computing system 130, and a training computing system 150 that are communicatively coupled over a network 180.

The computing device 102 can comprise any type of computing device, including, for example, a personal computing device (e.g., laptop computing device or desktop computing device), a mobile computing device (e.g., smartphone or tablet), a gaming console or controller, an embedded computing device, a wearable computing device (e.g., a smartwatch), or any other type of computing device.

The computing device 102 includes one or more processors 112 and a memory 114. The one or more processors 112 can be any suitable processing device (e.g., a processor core, a microprocessor, an ASIC, an FPGA, a controller, and/or a microcontroller) and can be one processor or a plurality of processors that are operatively connected. The memory 114 can include one or more non-transitory computer-readable storage media, such as RAM, ROM, EEPROM, EPROM, flash memory devices, magnetic disks, and/or combinations thereof. The memory 114 can store data 116 and instructions 118 which are executed by the processor 112 to cause the computing device 102 to perform operations.

In some implementations, the computing device 102 can store or include one or more machine-learned models 120. For example, the one or more machine-learned models 120 can be or can otherwise include various machine-learned models such as neural networks (e.g., deep neural networks) or other types of machine-learned models, comprising non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Further, the one or more machine-learned models 120 can comprise one or more large language models (LLMs), one or more generative adversarial networks (GANs), one or more encoders, one or more decoders, one or more auto-encoders, and/or one or more embedding models. Examples of one or more machine-learned models 120 are discussed with reference to FIGS. 1-13.

In some implementations, the one or more machine-learned models 120 can be received from the server computing system 130 over network 180, stored in the memory 114, and then used or otherwise implemented by the one or more processors 112. In some implementations, the computing device 102 can implement multiple parallel instances of a single machine-learned model of the one or more machine-learned models 120 (e.g., to perform parallel scan node determination, instruction generation, and/or reconstructed three-dimensional representation generation operations across multiple instances of the one or more machine-learned models 120).

More particularly, the one or more machine-learned models 120 can comprise one or more machine-learned models (e.g., one or more auto-encoders) that are configured and/or trained to perform operations comprising receiving image data comprising a plurality of two-dimensional images associated with a path through a physical space, determining a plurality of scan nodes associated with the path, generating a plurality of instructions associated with capturing a plurality of scanned images of the physical space, generating, the plurality of scanned images, and/or generating a reconstructed three-dimensional representation of the physical space.

Additionally or alternatively, one or more machine-learned models 140 can be included in or otherwise stored and implemented by the server computing system 130 that communicates with the computing device 102 according to a client-server relationship. For example, the one or more machine-learned models 140 can be implemented by the server computing system 130 as a portion of a web service (e.g., a scan node determination service, instruction generation service, and/or reconstructed three-dimensional representation generation service). Thus, one or more machine-learned models 120 can be stored and implemented at the computing device 102 and/or one or more machine-learned models 140 can be stored and implemented at the server computing system 130.

The computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an NPU, an FPGA, a controller, and/or a microcontroller) and can be one processor or a plurality of processors that are operatively connected. The memory 134 can include one or more non-transitory computer-readable storage media, such as RAM, ROM, EEPROM, EPROM, flash memory devices, magnetic disks, and/or combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the one or more machine-learned models 140 can be or can otherwise include various machine-learned models. Example machine-learned models include auto-encoders, neural networks, and/or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Examples of one or more machine-learned models 140 are discussed with reference to FIGS. 1-13.

The computing device 102 and/or the server computing system 130 can train the one or more machine-learned models 120 and/or the one or more machine-learned models 140 via interaction with the training computing system 150 that can be communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, and/or a microcontroller) and can be one processor or a plurality of processors that are operatively connected. The memory 154 can include one or more non-transitory computer-readable storage media, such as RAM, ROM, EEPROM, EPROM, flash memory devices, magnetic disks, and/or combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the one or more machine-learned models 120 and/or the one or more machine-learned models 140 stored at the computing device 102 and/or the server computing system 130 using various training or learning techniques (e.g., machine-learning techniques), such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a plurality of training iterations.

In some implementations, performing backwards propagation of errors can include performing truncated backpropagation through time. The model trainer 160 can perform a number of generalization techniques (e.g., weight decays, dropouts, and/or other generalization techniques.) to improve the generalization capability of the models being trained. In particular, the model trainer 160 can train the one or more machine-learned models 120 and/or the one or more machine-learned models 140 based on a set of training data 162. The training data 162 can include various types of data. For example, the training data 162 can include image data, scan node data, and/or reconstructed representation data. For example, the training data 162 can comprise training image data comprising a plurality of two-dimensional training images, training scan node data, and a corresponding plurality of ground-truth reconstructed three-dimensional representations. The model trainer 160 can train and/or retrain the one or more machine-learned models 120 and/or the one or more machine-learned models 140 based on additional data from the training data 162 which can comprise additional image data (e.g., updated image data) and/or additional scan node data (e.g., updated scan node data), new types of image data (e.g., new types of image data based on new image formats) and/or scan node data (e.g., new types of scan node data), and/or one or more modifications to existing image data and/or scan node data.

In some implementations, if a user has provided consent (e.g., the user provides affirmative consent for another party to use the user's image data, scan node data, and/or reconstructed three-dimensional representation data), the training examples can be provided by the computing device 102. Thus, in such implementations, the one or more machine-learned models 120 provided to the computing device 102 can be trained by the training computing system 150 on user-specific data received from the computing device 102. In some instances, this process can be referred to as personalizing the model.

The model trainer 160 includes computer logic utilized to provide desired functionality. The model trainer 160 can be implemented in hardware, firmware, and/or software controlling a general-purpose processor. For example, in some implementations, the model trainer 160 includes program files stored on a storage device, loaded into a memory, and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification can be used in a variety of tasks, applications, and/or use cases. In some implementations, the input to the machine-learned model(s) of the present disclosure can be text or natural language data. The machine-learned model(s) can process the text or natural language data to generate an output (e.g., based on inputting queries from a user the machine-learned model(s) can process and generate an analysis comprising one or more explanations and visualizations associated with the queries and/or image data of the user). As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language). As another example, the machine-learned model(s) can process the text or natural language data to generate a prediction output.

In some implementations, the input to the machine-learned model(s) of the present disclosure can comprise speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data). As another example, the machine-learned model(s) can process the speech data to generate an upscaled speech output (e.g., speech data that is higher quality than the input speech data). As another example, the machine-learned model(s) can process the speech data to generate a textual representation output (e.g., a textual representation of the input speech data). As another example, the machine-learned model(s) can process the speech data to generate a prediction output.

In some implementations, the input to the machine-learned model(s) of the present disclosure can comprise latent encoding data (e.g., a latent space representation of an input). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can comprise statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can comprise sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task can be an audio compression task. The input can include audio data and the output can comprise compressed audio data. In another example, the input includes visual data (e.g., one or more images or videos), the output comprises compressed visual data, and the task is a visual data compression task. In another example, the task can comprise generating an embedding for input data (e.g., input audio data or visual data).

In some cases, the input includes audio data representing a spoken utterance and the task is a speech recognition task. The output can comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the computing device 102 can include the model trainer 160 and the training data 162. In such implementations, the one or more machine-learned models 120 can be both trained and used locally at the computing device 102. In some of such implementations, the computing device 102 can implement the model trainer 160 to personalize the one or more machine-learned models 120 based on user-specific data.

FIG. 1B depicts a block diagram of an example computing device that can generate reconstructed three-dimensional representations according to example embodiments of the present disclosure. A computing device 10 can be a user computing device or a server computing device.

The computing device 10 can include a number of applications (e.g., applications 1 through N). Each application contains its own machine-learned library and machine-learned model(s). For example, each application can include a machine-learned model. Example applications include an image data processing application, a scan node data generation application, a reconstructed three-dimensional representation generation application, a mapping application, a navigation application, a social media application, a text messaging application, an email application, a dictation application, a virtual keyboard application, and/or a browser application.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device that can generate reconstructed three-dimensional representations according to example embodiments of the present disclosure. A computing device 50 can be a user computing device or a server computing device.

The computing device 50 includes a number of applications (e.g., applications 1 through N). Each application is in communication with a central intelligence layer. Example applications include an image processing application (e.g., an application that is used to receive and/or process image data), a scan node determination application (e.g., an application that is used to determine scan nodes based on image data), a reconstructed three-dimensional representation generation application (e.g., an application that is used to generate reconstructed three-dimensional representations based on image data and/or scanned images), a mapping application, a navigation application, a text messaging application, an email application, a dictation application, a virtual keyboard application, and/or a browser application. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

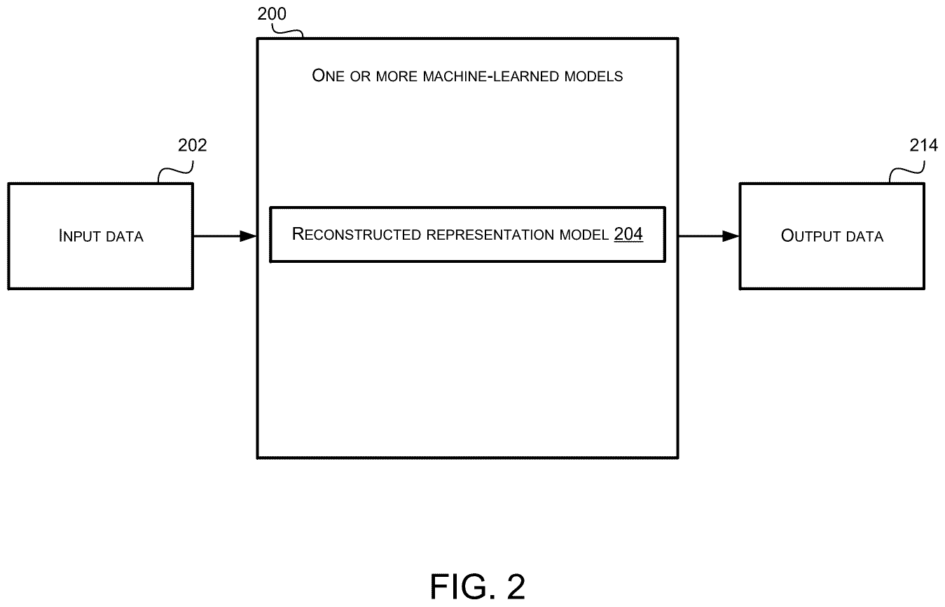

FIG. 2 depicts a block diagram of examples of machine-learned models according to example embodiments of the present disclosure. In some implementations, the one or more machine-learned models 200 can be trained to receive input data 202 that can comprise image data (e.g., image data comprising a plurality of two-dimensional images) and/or scan node data (e.g. scan node data comprising a plurality of scanned images and/or locations at which the plurality of scanned images were captured). As a result of receipt of the input data 202 the one or more machine-learned models 200 can generate output data 214 that can comprise a reconstructed three-dimensional representation of a physical space and/or predicted dimensions of a physical space.

In some implementations, the one or more machine-learned models 200 can include a reconstructed representation model 204 that is operable to generate reconstructed three-dimensional representations based on the input data 202 (e.g., input data comprising image data and/or scan node data comprising a plurality of scanned images).

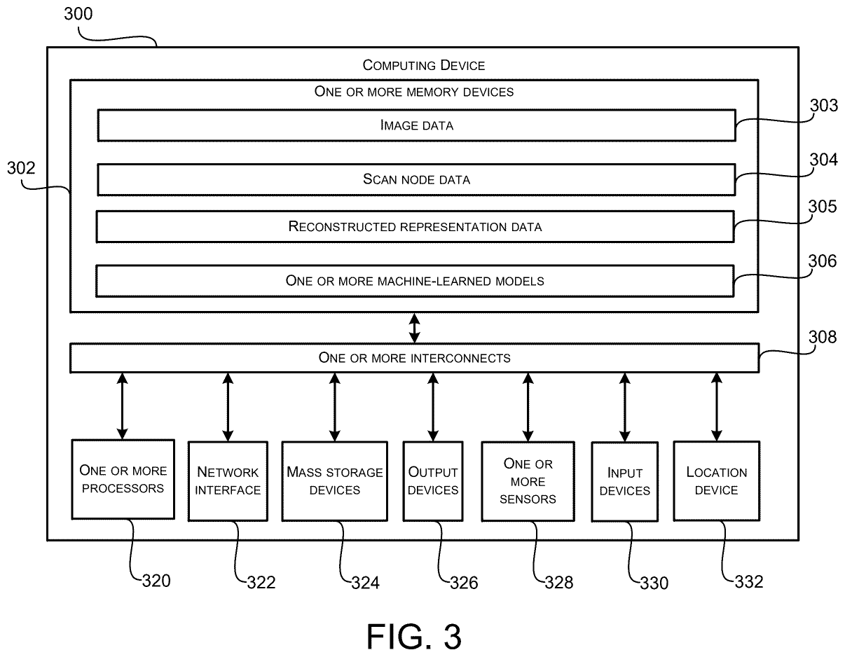

FIG. 3 depicts an example of a computing device according to example embodiments of the present disclosure. A computing device 300 can include one or more features and/or capabilities of the computing device 102, the server computing system 130, and/or the training computing system 150. Furthermore, the computing device 300 can perform one or more actions and/or operations performed by the computing device 102, the server computing system 130, and/or the training computing system 150, which are described with respect to FIG. 1A.

As shown in FIG. 3, the computing device 300 can include one or more memory devices 302, image data 303, scan node data 304, reconstructed representation data 305, one or more machine-learned models 306, one or more interconnects 308, one or more processors 320, a network interface 322, one or more mass storage devices 324, one or more output devices 326, one or more sensors 328, one or more input devices 330, and/or the location device 332. The computing device 300 can be configured as a desktop computing device and/or a mobile computing device (e.g., a smartphone, tablet computing device, and/or laptop computing device). Further, the computing device 300 can process and/or generate data (e.g., reconstructed representation data) based on data (e.g., image data) of the computing device 300 and/or data that is received from another computing device (e.g., image data that is generated by a remote computing device).

The one or more memory devices 302 can store information and/or data (e.g., the image data 303, the scan node data 304, the reconstructed representation data 305, and/or the one or more machine-learned models 306). Further, the one or more memory devices 302 can include one or more computer-readable mediums (e.g., tangible non-transitory computer-readable media), including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations including receiving image data comprising a plurality of two-dimensional images associated with a path through a physical space, determining a plurality of scan nodes associated with the path, generating a plurality of instructions associated with capturing a plurality of scanned images of the physical space, generating, the plurality of scanned images, and/or generating a reconstructed three-dimensional representation of the physical space.

The image data 303 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. The image data 303 can comprise a plurality of two-dimensional images. The plurality of two-dimensional images can be associated with a path through a physical space. For example, the image data 303 can comprise a plurality of two-dimensional images of the interior of a restaurant that were captured on a path that includes a walk-through of the restaurant's main dining area. In some embodiments, the image data 303 can be received from one or more computing systems (e.g., the server computing system 130 that is depicted in FIG. 1A) which can include one or more computing systems that are remote from the computing device 300. Further, the plurality of two-dimensional images of the image data 303 can be processed and used by an application implemented by the computing device 300 and/or another computing device. For example, the image data 303 can be associated with a map application and can comprise images that can be associated with various geographic locations indicated in the map application.

The scan node data 304 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. In some embodiments, the scan node data 304 can be received from one or more computing systems (e.g., the server computing system 130 that is depicted in FIG. 1A) which can include one or more computing systems that are remote from the computing device 300. The scan node data 304 can comprise a plurality of scan nodes that correspond to the locations at which a portion of the plurality of two-dimensional images of the image data 303 were captured.

The reconstructed representation data 305 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the reconstructed representation data 305 can include reconstructed three-dimensional representation data that includes information associated with a reconstruction of scanned images (e.g., scanned two-dimensional images). In some embodiments, the reconstructed representation data 305 can be received from one or more computing systems (e.g., the server computing system 130 that is depicted in FIG. 1A) which can include one or more computing systems that are remote from the computing device 300.

The one or more machine-learned models 306 (e.g., the one or more machine-learned models 120, the one or more machine-learned models 140, and/or the machine-learned models 200) can include one or more portions of the data 116, the data 136, and/or the data 156 which are depicted in FIG. 1A and/or instructions (e.g., the instructions 118, the instructions 138, and/or the instructions 158 which are depicted in FIG. 1A) that are stored in the memory 114, the memory 134, and/or the memory 154, respectively. Furthermore, the one or more machine-learned models 306 can be configured and/or trained to perform operations comprising receiving image data comprising a plurality of two-dimensional images associated with a path through a physical space, determining a plurality of scan nodes associated with the path, generating a plurality of instructions associated with capturing a plurality of scanned images of the physical space, generating, the plurality of scanned images, and/or generating a reconstructed three-dimensional representation of the physical space. In some embodiments, the one or more machine-learned models 306 can be received from one or more computing systems (e.g., the server computing system 130 that is depicted in FIG. 1A) which can include one or more computing systems that are remote from the computing device 300.

The one or more interconnects 308 can include one or more interconnects or buses that can be used to send and/or receive one or more signals (e.g., electronic signals) and/or data (e.g., the image data 303, the scan node data 304, the reconstructed representation data 305, and/or the one or more machine-learned models 306) between devices of the computing device 300, including the one or more memory devices 302, the one or more processors 320, the network interface 322, the one or more mass storage devices 324, the one or more output devices 326, the one or more sensors 328, and/or the one or more input devices 330. The one or more interconnects 308 can be arranged or configured in different ways, including as parallel or serial connections. Further the one or more interconnects 308 can include one or more internal buses to connect the internal components of the computing device 300; and one or more external buses used to connect the internal components of the computing device 300 to one or more external devices. By way of example, the one or more interconnects 308 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), neural processing units (NPUs), and/or one or more graphics processing units (GPUs). Further, the one or more processors 320 can perform one or more actions and/or operations including one or more actions and/or operations associated with the image data 303, the scan node data 304, the reconstructed representation data 305, and/or the one or more machine-learned models 306. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). Further, the network interface 322 can be used to receive data (e.g., image data) from other computing devices. The one or more mass storage devices 324 (e.g., a hard disk drive and/or a solid-state drive) can be used to store data including the image data 303, the scan node data 304, the reconstructed representation data 305, and/or the one or more machine-learned models 306.

The one or more output devices 326 can include one or more display devices (e.g., LCD display, OLED display, Mini-LED display, microLED display, plasma display, and/or CRT display), one or more light sources (e.g., LEDs), one or more audio output devices (e.g., one or more loudspeakers), and/or one or more haptic output devices (e.g., one or more devices that are configured to generate vibratory output). For example, the one or more output devices 326 can comprise a touch sensitive display that is used to output an interface (e.g., a user interface) that can be configured to display indications based on the image data 303, the scan node data 304, and/or the reconstructed representation data 305.

The one or more sensors 328 can comprise one or more LiDAR devices, one or more sonar devices, one or more radar devices, one or more accelerometers, one or more gyroscopes, one or more altimeters, and/or one or more temperature sensors (e.g., one or more thermometers). The one or more input devices 330 can include one or more keyboards, one or more touch sensitive devices (e.g., a touch screen display), one or more buttons (e.g., a power button and/or volume buttons), one or more microphones, and/or one or more imaging devices (e.g., one or more cameras).

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, network interfaces, which can be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including the reconstructed representation data 305. The one or more memory devices 302 can be used to operate various applications including a mobile operating system developed specifically for mobile devices. As such, the one or more memory devices 302 can store instructions that allow the software applications to access data including data associated with the determination of scan nodes, the generation of instructions associated with capturing scanned images of a physical space, and/or the generation of reconstructed representation data. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 1A. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g., a GPS system, a Galileo positioning system, the GLObal Navigation satellite system (GLONASS), and/or the BeiDou Satellite Navigation and Positioning system), an inertial navigation system, a dead reckoning system, based on IP address, by using triangulation and/or proximity to cellular towers and/or Wi-Fi hotspots.

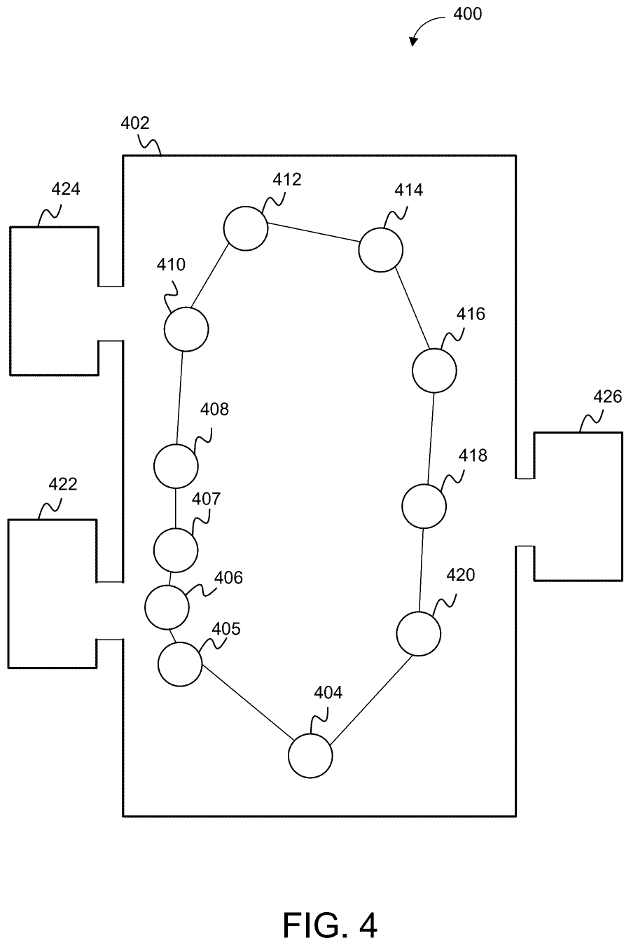

FIG. 4 depicts an example of determining scan nodes according to example embodiments of the present disclosure. The scan nodes generated in the physical space 402 can be generated using computing systems that include one or more features and/or capabilities of the computing device 102, the server computing system 130, the training computing system 150, and/or the computing device 300.

The environment 400 can comprise a physical space 402, a plurality of scan nodes 404-420, region 422, region 424, and/or region 426. The physical space 402 (e.g., a three-dimensional physical space) can comprise an interior space. For example, the physical space 402 can comprise a room inside a building (e.g., a hotel, an office building, a restaurant, an apartment, or residential house). The plurality of scan nodes 404-420 can be part of a path that can be used in the generation of a reconstructed three-dimensional representation. The path comprising the plurality of scan nodes 404-420 can comprise a predetermined path (e.g., a path that was generated based on traversal (e.g., a walkthrough) of the physical space 402) and/or a generated path (e.g., a path generated based on processing two-dimensional images of the physical space 402).

Further, a reconstructed three-dimensional representation based on the plurality of scan nodes 404-420 can comprise a representation of the physical space from the point of view of any location including the plurality of scan nodes 404-420 and/or the locations between a set of the plurality of scan nodes. For example, a reconstructed three-dimensional representation based on the plurality of scan nodes 404-420 can include a reconstruction based on scanned images captured at each of the plurality of scan nodes 404-420 and/or the locations between consecutive nodes of the plurality of scan nodes 404-420 (e.g., locations between scan node 408 and scan node 410, scan node 412 and scan node 414, or scan node 418 and scan node 420). In this example, the scan node 406 can be determined to be in a location that enables scanned images of the region 422 (e.g., a sub-room, alcove, closet, or niche) to be captured. The scan nodes 405-407 can be positioned to allow for a greater portion of the region 422 to be captured. For example, scanned images captured from the scan node 406 can capture portions of the region 422 including portions of the region 422 that are directly in front of the scan node 406. Scanned images captured from the scan node 405 can include images captured from portions of the region 422 that are to the right of the scan node 406 and which may not be visible from the location of the scan node 406. Scanned images captured from the scan node 407 can include images captured from portions of the region 422 that are to the left of the scan node 406 and which may not be visible from the location of the scan node 406.

Further, the scan node 410 can be determined to be in a location that enables scanned images of the region 424 (e.g., a sub-room, alcove, closet, or niche) to be captured and the scan node 418 can be determined to be in a location that enables scanned images of the region 426 (e.g., a sub-room, alcove, closet, or niche) to be captured. In some embodiments, scanned images captured at each of the plurality of scan nodes 404-420 can comprise scanned images captured from a substantially omnidirectional field of view from the viewpoint of each of the plurality of scan nodes 404-420. For example, a plurality of scanned images captured from the scan node 414 can comprise a plurality of images captured from a substantially omnidirectional field of view comprising the floor, ceiling, walls, and other interior regions of the physical space 402 from the viewpoint of the scan node 414.

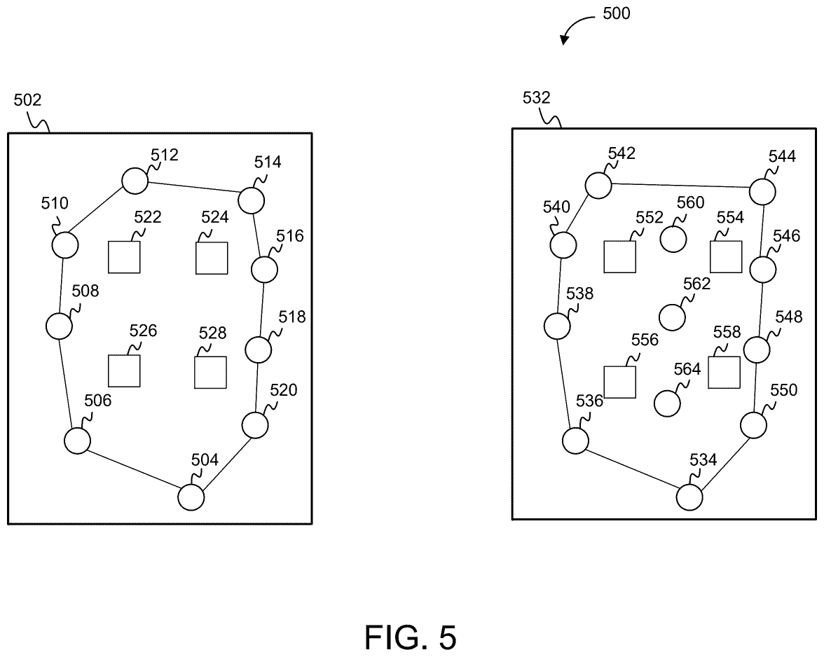

FIG. 5 depicts an example of determining scan nodes according to example embodiments of the present disclosure. The environment 500 can be processed using computing systems that include one or more features and/or capabilities of the computing device 102, the server computing system 130, the training computing system 150, and/or the computing device 300.

The environment 500 can comprise a physical space 502, a plurality of scan nodes 504-520, a plurality of objects 522-528, the physical space 532, a plurality of nodes 534-550, a plurality of objects 552-558, and/or a plurality of nodes 560-564. The physical space 502 (e.g., a three-dimensional physical space) and/or the physical space 532 can comprise an interior space or an exterior space that may be partially enclosed. For example, the physical space 502 and/or the physical space 532 can comprise an interior space such as a room inside a building or a partially enclosed exterior space such as a patio. The plurality of scan nodes 504-520, the plurality of scan nodes 534-550, and/or the plurality of scan nodes 560-564 can be part of a path that can be used in the generation of a reconstructed three-dimensional representation. The path comprising the plurality of scan nodes 504-520 can comprise a predetermined path (e.g., a path that was generated based on traversal of the physical space 502). The path that comprises the plurality of scan nodes 534-550 and the plurality of scan nodes 560-564 can comprise a generated path (e.g., a path generated based on processing two-dimensional images of the physical space 532).

Further, a reconstructed three-dimensional representation based on the plurality of scan nodes 504-520, the plurality of scan nodes 534-550, and/or the plurality of scan nodes 560-564 can comprise a representation of the physical space from the point of view of any location including the plurality of scan nodes 504-520, the plurality of scan nodes 534-550, and/or the plurality of scan nodes 560-564.

The physical space 502 the plurality of scan nodes 504-520 are arranged along a predetermined path. Further, the physical space 502 comprises the plurality of objects 522-528. For example, the plurality of objects 522-528 can comprise tables that are arranged in the physical space 502. In the physical space 502, the plurality of scan nodes 504-520 can be located on a path that encircles the plurality of objects 522-528.

The physical space 532 the plurality of scan nodes 534-528 can be determined to be located along a generated path. Further, the physical space 532 comprises the plurality of objects 552-558. For example, the plurality of objects 522-528 can comprise desks or tables that are arranged in the physical space 532. In the physical space 532, the plurality of scan nodes 534-550 can be located on a path that encircles the plurality of objects 552-558. Additionally, the plurality of scan nodes 560-564 can be determined to be located in an approximately central portion of the physical space 532 between the plurality of objects 560-564. The locations of the plurality of scan nodes 560-564 enables additional scanned images to be captured from a viewpoint closer to the center of the physical space 532. Further, the plurality of scan nodes 560-564 can enable the capture of scanned images from the viewpoint of the center of the physical space 532 looking outwards at the edges (e.g., walls) of the physical space 532.

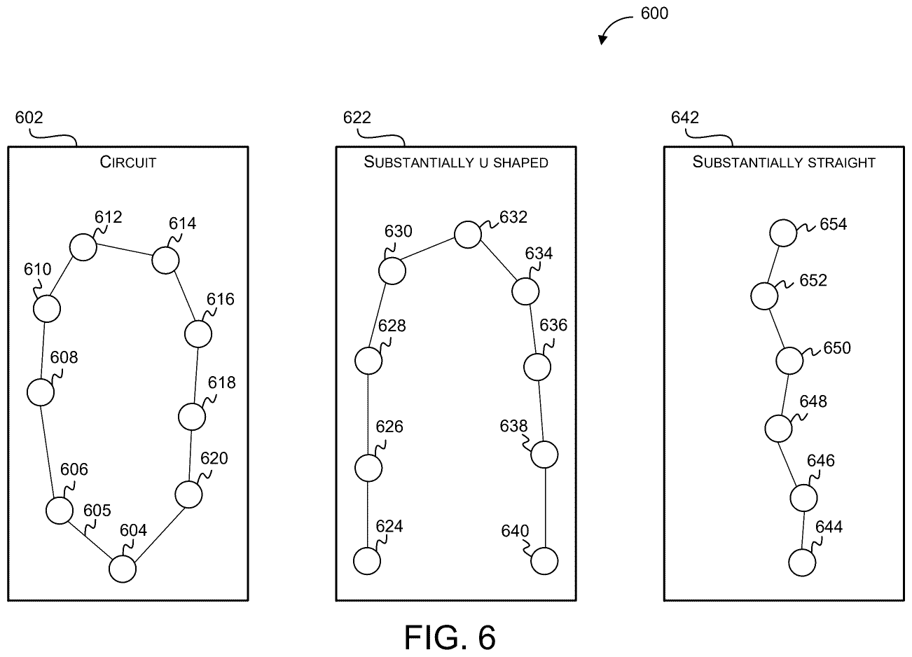

FIG. 6 depicts an example of different types of paths according to example embodiments of the present disclosure. Paths through the physical spaces 600 can be processed (e.g., determined and/or generated) using one or more computing systems and/or one or more computing devices that include one or more features and/or capabilities of the computing device 102, the server computing system 130, the training computing system 150, and/or the computing device 300.

The physical spaces 600 can comprise a physical space 602, a physical space 622, and a physical space 642, each of which can be room or other interior area of a building. The physical space 602 can comprise a path comprising a plurality of scan nodes 604-620 and a plurality of edges comprising an edge 605. The physical space 622 can comprise a path comprising a plurality of scan nodes 624-640. Further, the physical space 642 can comprise a path comprising a plurality of scan nodes 644-654. A computing system can determine and/or generate various paths comprising a plurality of scan nodes located throughout a physical space. The computing system can determine and/or generate a path based on various factors that can include the dimensions of the physical space, the locations of one or more objects in the physical space, a length of the path (e.g., a length of the path based on a predetermined length), and/or an estimated time to traverse the path (e.g., a time threshold (e.g., 30 seconds) can be used to determine an estimated time to traverse a path at a walking velocity (e.g., a walking velocity of 5 kilometers per hour)). Further, the computing system can determine and/or generate a plurality of scan nodes at locations in which a view of the physical space is not occluded (e.g., blocked by an object such as a pillar or pole) and in which access to the scan node is not obstructed (e.g., the location of the scan node is not occupied by a table or fountain that would obstruct the placement of an image capture device to capture scanned images). In some embodiments, the beginning and/or end of a path can be associated with an entrance and/or exit (e.g., an opening to a physical space that allows access to the physical space and which can include a doorway or other entryway). For example, a path can begin at an entrance or exit and end at an entrance or exit. In some embodiments, an entrance can also be an exit. Further, a physical space can comprise one or more entrances and/or one or more exits.

The physical space 602 can comprise a path comprising the plurality of scan nodes 604-620 which are arranged in a circuit that can start at the scan node 604, is connected by edges (e.g., the edge 605 connecting the scan node 604 to the scan node 606), and continue to the next scan node (e.g., scan node 606) in the path associated with the physical space 602 until returning to the scan node 604 at which the path associated with the physical space 602 may end. For example, the path of the plurality comprising the plurality of scan nodes 604-620 can begin at the scan node 604 and continue to the scan node 606 via the edge 605, then continue to the plurality of scan nodes 608-620 until returning to the scan node 604. In some embodiments, the path associated with the physical space 602 that comprises the plurality of scan nodes 604-620 can begin at other scan nodes (e.g., the scan node 610 or the scan node 620) and can be traversed in a different direction (e.g., beginning at the scan node 604 and continuing to the scan node 620 through scan node 606 until returning to the scan node 604). The circuit configuration of the path associated with the physical space 602 comprising the plurality of scan nodes 604-620 can include scan nodes from which scanned images of the perimeter (e.g., the walls of a room) of the physical space associated with the 602 can be captured at a closer distance.

The physical space 622 can comprise a path comprising the plurality of scan nodes 624-640 which are connected by edges and arranged in a substantially U shaped configuration that begins with the scan node 624 and continues to the next scan node (e.g., the scan node 626) in the path associated with the physical space 622 until ending at the scan node 640. For example, the path associated with the physical space 622 that comprises the plurality of scan nodes 624-640 can begin at the scan node 624 and continue to the scan node 626, then continue to the plurality of scan nodes 628-638 until ending at scan node 640. In some embodiments, the path of the plurality of scan nodes 624-640 can begin at other scan nodes (e.g., the scan node 640) and can be traversed in a different direction (e.g., beginning at the scan node 640 and continuing to the scan node 624). The substantially U shaped configuration of the plurality of scan nodes 624-640 can be shorter than the circuit configuration of the plurality of scan nodes 604-620 and may start near an entrance close to the scan node 624 and end at an exit near the scan node 640.

The physical space 642 can comprise a path comprising the plurality of scan nodes 644-654 which are connected by edges and arranged in a substantially straight configuration that starts at the scan node 644 and continues to the next scan node in the path until ending at the scan node 654. For example, a path associated with the physical space 642 can begin at the scan node 644 and continue to the scan node 646, then continue to the plurality of scan nodes 648-652 until ending at the scan node 654. In some embodiments, a path associated with the physical space 642 can begin at other scan nodes (e.g., the scan node 654) and can be traversed in a different direction (e.g., beginning at the scan node 654 and ending at the scan node 644). The substantially straight configuration of the plurality of scan nodes 644-654 can be shorter than the circuit configuration of the plurality of scan nodes 604-620 and may start near an entrance close to the scan node 644 and end at an exit near the scan node 654. Additionally, the substantially straight configuration of the plurality of scan nodes 644-654 may provide improved coverage of the central area of the physical space associated with the path through the physical space 642.

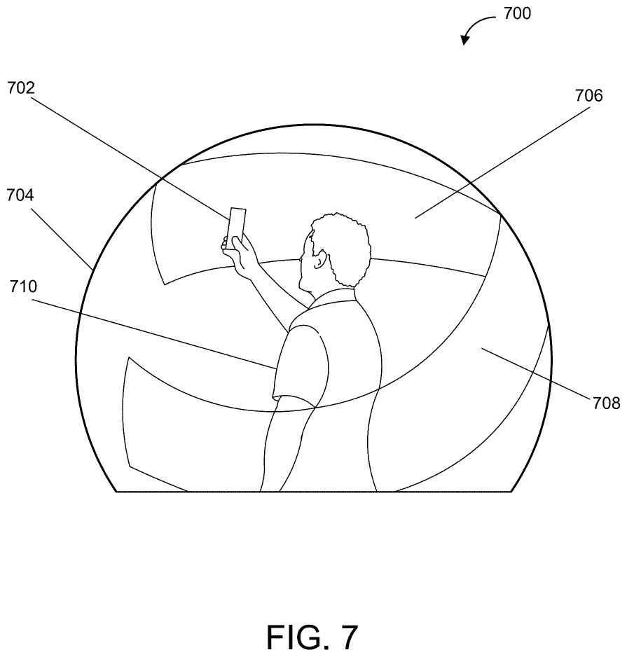

FIG. 7 depicts an example of capturing scanned images of a physical space according to example embodiments of the present disclosure. The operations associated with the physical space 700 can be performed using one or more computing systems and/or one or more computing devices that include one or more features and/or capabilities of the computing device 102, the server computing system 130, the training computing system 150, and/or the computing device 300.

The physical space 700 can comprise an image capture device 702, a scan node 704, a scanned image capture area 706, a scanned image capture area 708, and a user 710. The image capture device 702 can comprise a smartphone that comprises one or more cameras that can be used to capture scanned images of the physical space 700 (e.g., a three-dimensional physical space) around the scan node 704 which comprises a location within the physical space 700. In this example, based on instructions (e.g., instructions associated with capturing scanned images of the three-dimensional physical space around the scan node 704) indicated on a display of the image capture device 702, scanned images of the scanned image capture area 706 in front of the user 710 and scanned images of the scanned image capture area 708 behind the user 710 have been captured. The image capture device 702 can display indications of the portions of the physical space around the user 710 that have been scanned by the image capture device 702. Further, the image capture device 702 can generate instructions comprising directions to position the image capture device 702 to capture the portions of the physical space 700 that have not yet been scanned by the image capture device 702.

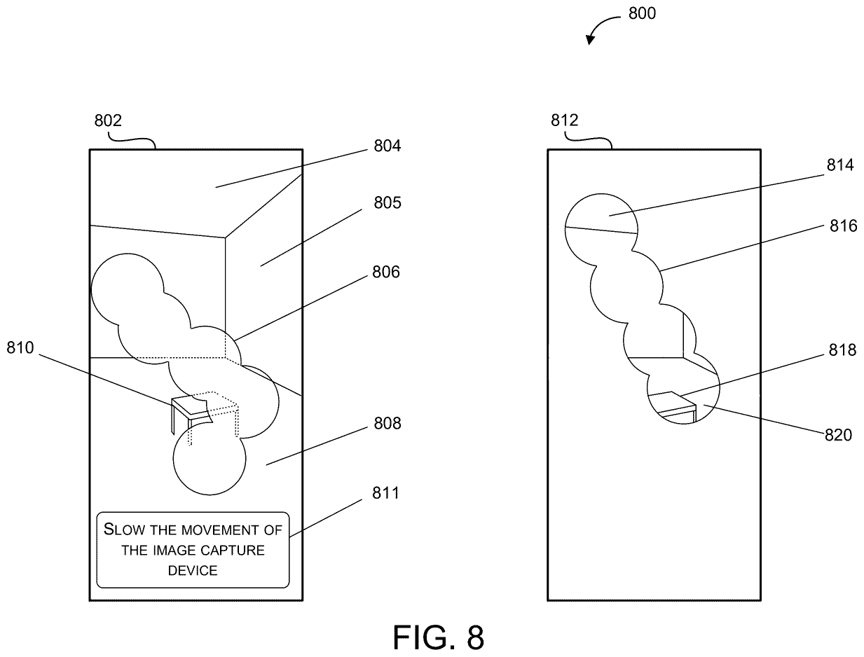

FIG. 8 depicts an example of interfaces for capturing scanned images of a physical space and mitigating camera blur according to example embodiments of the present disclosure. The interfaces 800 can be generated using one or more computing systems and/or one or more computing devices that include one or more features and/or capabilities of the computing device 102, the server computing system 130, the training computing system 150, and/or the computing device 300.

The interfaces 800 comprise the interface 802, the physical space indication 804, the physical space indication 805, the scanned image indication 806, the physical space indication 808, the object indication 810, the physical space indication 814, the scanned image indication 816, the object indication 818, and the object indication 820.

The interfaces 800 (e.g., user interfaces that can be generated and/or displayed on a smartphone and/or an augmented reality headset) can indicate the portions of a physical space from which scanned images of the physical space have been captured. In the interface 802, the physical space displayed in the interface 802 comprises a room in which a table is positioned. The physical space indicated in the interface 802 comprises the physical space indication 804 (e.g., a ceiling), the physical space indication 805 (e.g., a wall), the physical space indication 808 (e.g., a floor), and the object indication 810 (e.g., a table). In the interface 802, scanned images of the physical space have been captured. The scanned image indication 806 indicates the portions of the physical space that have been captured. The appearance of the portions of the physical space that have been captured can be modified within the interface 802. In this example, the portions of the physical space that have been captured can be indicated in the interface 802 as having dotted lines and the portions of the physical space that have not been captured can be indicated in the interface 802 as having solid lines.

The computing device (e.g., an image capture device) that generates the interface 802 can be configured to determine a velocity and/or acceleration of the computing device and/or an image capture rate (e.g., a scanned image capture rate) of the computing device. Based on the computing device that generates the interface moving at a velocity that results in blurring of the scanned images of the physical space, the computing device can generate an indication to slow down the movement of the computing device that generates the interface 802 and captures the scanned images of the physical space indicated in the interface 802. For example, based on the image capture device capturing scanned images at a rate that exceeds a scanned image capture rate, the indication 811 can indicate “SLOW THE MOVEMENT OF THE IMAGE CAPTURE DEVICE” to indicate that movement (e.g., movement to scan the physical space and capture images) of the image capture device that captures scanned images of the physical space should be slowed down. Slowing down the movement of the image capture device can reduce the occurrence of blurring in scanned images.

In the interface 812, the physical space comprises a room in which a table is positioned. The interface 812 can indicate the same physical space that is indicated in the interface 802. The physical space indicated in the interface 812 comprises the physical space indication 814 (e.g., a ceiling), the object indication 818 (e.g., a table), and the object indication 820 (e.g., a floor). In the interface 812, scanned images of the physical space have been captured. The scanned image indication 816 indicates the portions of the physical space that have been captured. The appearance of the portions of the physical space that have been captured can be modified within the interface 812. In this example, the portions of the physical space that have been captured are visible and indicated in the interface 812 and the portions of the physical space that have not been captured are not visible and are indicated in the interface 812 as not being visible (e.g., a solid white color). In some embodiments, other indications of the physical space that are not visible can include various colors (e.g., black or green), a semi-transparent overlay of an image of the physical space (e.g., the physical space appears slightly darker or slightly blurred), or a pattern overlay that comprises a pattern (e.g., a checkered pattern or other pattern) over the image of the physical space. As more portions of the physical space are captured, the scanned image indication 816 can indicate more visible portions of the physical space.

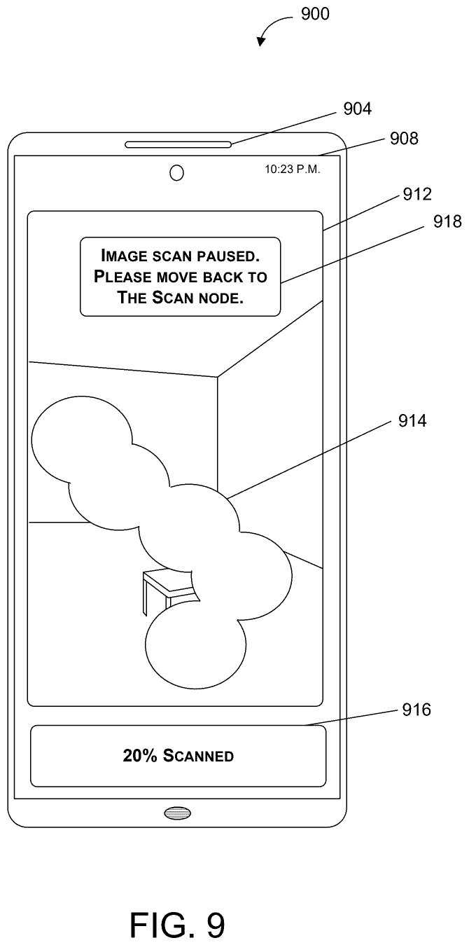

FIG. 9 depicts an example of a computing device generating an interface for mitigating scanned image capture interruptions according to example embodiments of the present disclosure. The computing device 900 can comprise one or more features and/or capabilities of the computing device 102, the server computing system 130, the training computing system 150, and/or the computing device 300.

The computing device 900 can include an imaging component 902, an audio output component 904, a display component 908, an interface 912, a scanned image indication 914, an indication 916, and/or an indication 918.

The computing device 900 can be configured to perform one or more operations comprising sending, receiving, processing, and/or generating data comprising image data (e.g., content data based on the content 910), scan node, reconstructed representation data, and/or other data received by the computing device 900. In some embodiments, an image capture device (e.g., a rear facing camera) of the computing device 900 component can be used to generate the image of the physical space displayed in the interface 912.

In this example, a portion of the physical space captured by the computing device 900 is indicated by the scanned image indication 914. Further, the portion of the physical space that has been captured is indicated by the indication 916 which indicates “20% SCANNED.” In this example, the computing device 900 has determined that the computing device 900 is not inside a scan node from which to capture scanned images of the physical space. As a result, the computing device 900 has generated the indication 918 which indicates “IMAGE SCAN PAUSED. PLEASE MOVE BACK TO THE SCAN NODE.” Based on a determination that the computing device 900 is located within the scan node, the computing device 900 can continue to capture scanned images of the physical space around the computing device 900. In some embodiments, the audio output component 904 can be used to generate audio indications (e.g., synthetic speech) to indicate to a user that the user should return to the scan node.

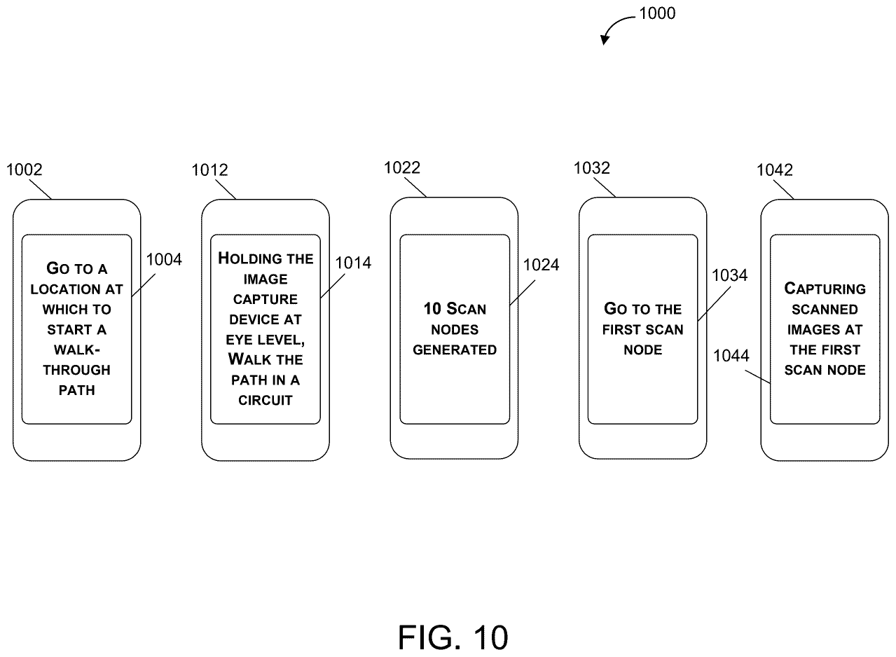

FIG. 10 depicts an example of interfaces for generating reconstructed three-dimensional representations according to example embodiments of the present disclosure. The interfaces 1000 can be generated using one or more computing systems and/or one or more computing devices that include one or more features and/or capabilities of the computing device 102, the server computing system 130, the training computing system 150, and/or the computing device 300.

The interfaces 1000 can comprise an interface 1002, an indication 1004, an interface 1012, an indication 1014, an interface 1022, an indication 1024, an interface 1032, an indication 1034, an interface 1042, and an indication 1044.

The interfaces 1000 (e.g., user interfaces that can be generated and/or displayed on a smartphone and/or an augmented reality headset) can indicate instructions (e.g., directions to capture scanned images of one or more portions of a physical space). The interfaces can comprise indications comprising instructions to capture scanned images of a physical space. Further, the interfaces can be generated sequentially such that the interface 1002 is displayed first, the interface 1012 is displayed after the interface 1002, the interface 1022 is displayed after the interface 1012, the interface 1032 is displayed after the interface 1022, and the interface 1042 is displayed after the interface 1032.

In the interface 1002, the indication 1004 which indicates “GO TO A LOCATION AT WHICH TO START A WALK-THROUGH PATH” is generated. The indication 1004 can comprise an instruction directing an operator of the image capture device that is associated with the interface 1002 to go to some location at which to start a walk-through path (e.g., an entrance of a room). In the interface 1012, the indication 1014 which indicates “HOLDING THE CAMERA AT EYE LEVEL, WALK THE PATH IN A CIRCUIT” is generated. The indication 1014 comprises an instruction directing an operator of the image capture device to position the image capture device at eye level (e.g., approximately 1.8 meters above the floor surface of the physical location) and walk the path in a circuit such that the path starts and ends at the same location. In the interface 1022, the indication 1024 which indicates “10 SCAN NODES GENERATED” is generated. The indication 1024 comprises an indication that 10 scan nodes associated with the physical space comprising the path have been generated. In the interface 1032, the indication 1034 which indicates “GO TO THE FIRST SCAN NODE” is generated. The indication 1034 comprises an instruction directing an operator of the image capture device to move to a location within the physical space that is associated with the first scan node (e.g., an entrance of a room at the start of the walk-through path). In the interface 1042, the indication 1044 which indicates “CAPTURING SCANNED IMAGES AT THE FIRST SCAN NODE” is generated. The indication 1044 comprises an indication that scanned images at the first scan node are being captured. After completion of capturing the scanned images at the first scan node, an interface comprising instructions directing a user to go to the next scan node (e.g., the second scan node) can be generated.

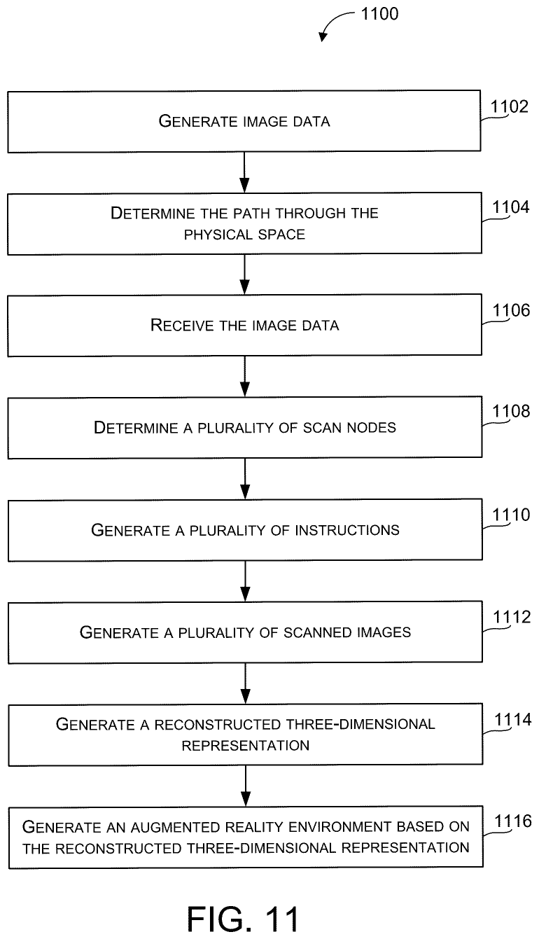

FIG. 11 depicts a flow chart diagram of an example method of generating reconstructed three-dimensional representations according to example embodiments of the present disclosure. One or more portions of the method 1100 can be executed and/or implemented on one or more computing devices and/or one or more computing systems that include one or more features and/or capabilities of the computing device 102, the server computing system 130, the training computing system 150, and/or the computing device 300. In some embodiments, one or more portions of the method 1100 can be executed and/or implemented on the computing device 102, the server computing system 130, the training computing system 150, and/or the computing device 300. Further, one or more portions of the method 1100 can be executed or implemented as an algorithm on the hardware devices or systems disclosed herein. FIG. 11 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1102, the method 1100 can include generating image data based on one or more directions to traverse a path through the physical space. The image data can comprise a plurality of two-dimensional images. For example, the computing device 102 can generate image data comprising a plurality of two-dimensional images of a physical space (e.g., a plurality of two-dimensional images of the interior of a room in a hotel).

At 1104, the method 1100 can include determining, based on the image data, a path through the physical space. For example, the computing device 102 can input the image data into one or more machine-learned models that are configured and/or trained to generate the path through the physical space. By way of further example, the path through the physical space can be based on a path algorithm (e.g., a path algorithm that generates a path that is within a predetermined distance of the walls of a physical space).

At 1106, the method 1100 can include receiving image data that can comprise a plurality of two-dimensional images associated with a path through a physical space. The image data can comprise the image date based on one or more directions to traverse a path through the physical space. For example, the computing device 102 can receive image data comprising a plurality of two-dimensional images (e.g., a plurality of two-dimensional images of the interior of a room in a hotel). The image data can be received from a local device (e.g., a device used to generate the image data) and/or from a remote source (e.g., a remote computing system) via a network such as the network 180.

At 1108, the method 1100 can include determining, based on the image data, a plurality of scan nodes associated with the path. The plurality of scan nodes can comprise locations at which to capture a plurality of scanned images of the physical space. For example, the computing device 102 can determine the plurality of scan nodes based on inputting the image data into one or more machine-learned models that are configured and/or trained to determine predicted dimensions of a physical space, determine the number of scan nodes associated with the physical space, and/or determine the locations of scan nodes within the physical space.

At 1110, the method 1100 can include generating, based on the plurality of scan nodes, a plurality of instructions associated with capturing the plurality of scanned images of the physical space. The plurality of instructions can comprise instructions to position an image capture device (e.g., a camera angle and/or orientation of a camera). Further, the plurality of instructions can comprise image capture device instructions comprising settings of an image capture device used to capture the plurality of scanned images (e.g., shutter speed settings, light sensitivity (ISO) settings, and/or zoom settings). For example, the computing device 102 can input the plurality of scan nodes and/or the image data into one or more machine-learned models that are configured and/or trained to generate the plurality of instructions associated with capturing the plurality of scanned images of the physical space.

At 1112, the method 1100 can include generating, based on the plurality of instructions, the plurality of scanned images associated with the plurality of scan nodes. For example, the computing device 102 can generate based on the plurality of instructions, the plurality of scanned images associated with the plurality of scan nodes. The plurality of instructions can comprise instructions to position an image capture device at the locations of the plurality of scan nodes and capture the plurality of scanned images from a plurality of camera angles at each of the plurality of scan nodes.

At 1114, the method 1100 can include generating, based on the plurality of two-dimensional images and the plurality of scanned images, a reconstructed three-dimensional representation of the physical space. For example, the server computing system 130 can perform a plurality of Gaussian splatting techniques and/or plurality of Gaussian splatting operations on the plurality of scanned images. The plurality of Gaussian splatting techniques and/or plurality of Gaussian splatting operations can be used to process the plurality of scanned images and generate the reconstructed three-dimensional representation of the physical space. In some embodiments, the server computing system 130 can implement one or more machine-learned models that can include a NeRF model that is configured and/or trained to generate the reconstructed three-dimensional representation of the physical space based in input comprising the image data and/or the plurality of scanned images.

At 1116, the method 1100 can include generating an augmented reality environment based on the reconstructed three-dimensional representation. For example, the computing device 102 can send the reconstructed three-dimensional representation to an augmented reality application implemented on the computing device 102. Further, the augmented reality application can be configured to generate an augmented reality environment based on the reconstructed three-dimensional representation.

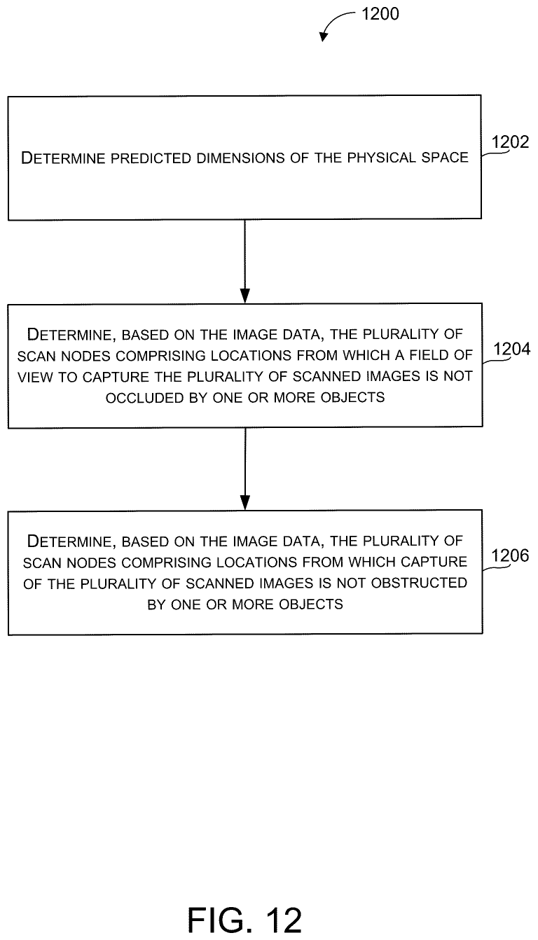

FIG. 12 depicts a flow chart diagram of an example method of determining predicted dimensions of a physical space and scan node locations according to example embodiments of the present disclosure. One or more portions of the method 1200 can be executed and/or implemented on one or more computing devices and/or one or more computing systems that include one or more features and/or capabilities of the computing device 102, the server computing system 130, the training computing system 150, and/or the computing device 300. In some embodiments, one or more portions of the method 1200 can be executed and/or implemented on the computing device 102, the server computing system 130, the training computing system 150, and/or the computing device 300. Further, one or more portions of the method 1200 can be executed or implemented as an algorithm on the hardware devices or systems disclosed herein. In some embodiments, one or more portions of the method 1200 can be performed as part of the method 1100 that is described with respect to FIG. 11. FIG. 12 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1202, the method 1200 can include determining, based on the image data, predicted dimensions of the physical space. For example, the computing device 102 can input the image data into one or more machine-learned models that are configured and/or trained to determine and/or generate predicted dimensions of physical space based on input comprising image data.

At 1204, the method 1200 can include determining, based on the image data, the plurality of scan nodes comprising locations from which a field of view to capture the plurality of scanned images is not occluded by one or more objects. For example, the server computing system 130 can input the image data into one or more machine-learned models that are configured and/or trained to determine, based on input comprising the image data, locations from which a field of view to capture the plurality of scanned images is not occluded by one or more objects.

At 1206, the method 1200 can include determining, based on the image data, the plurality of scan nodes comprising locations from which capture of the plurality of scanned images is not obstructed by one or more objects. For example, the computing device 102 can determine predicted dimensions of the physical space and determine locations of the plurality of scan nodes that can increase coverage of the three-dimensional space without occlusion or obstruction.

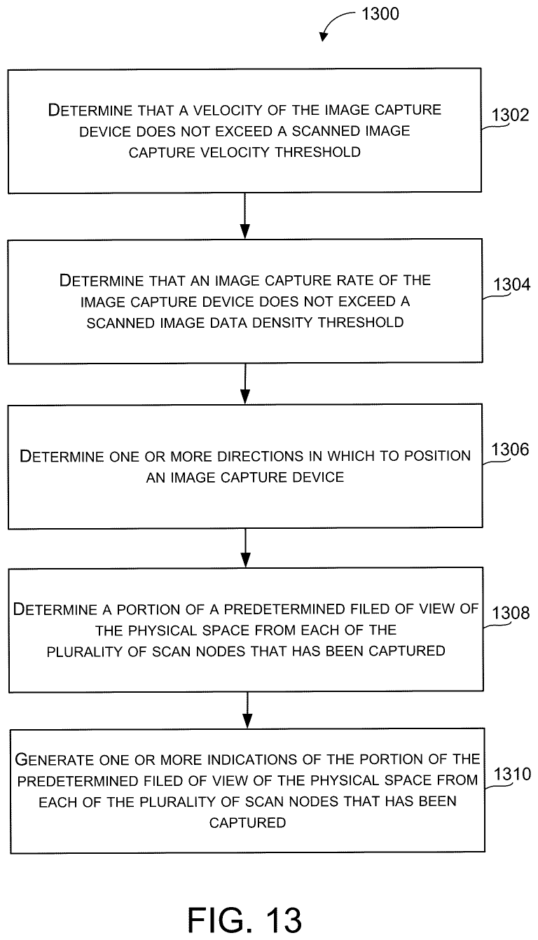

FIG. 13 depicts a flow chart diagram of an example method of generating scanned images according to example embodiments of the present disclosure. One or more portions of the method 1300 can be executed and/or implemented on one or more computing devices and/or one or more computing systems that include one or more features and/or capabilities of the computing device 102, the server computing system 130, the training computing system 150, and/or the computing device 300. In some embodiments, one or more portions of the method 1300 can be executed and/or implemented on the computing device 102, the server computing system 130, the training computing system 150, and/or the computing device 300. Further, one or more portions of the method 1300 can be executed or implemented as an algorithm on the hardware devices or systems disclosed herein. In some embodiments, one or more portions of the method 1300 can be performed as part of the method 1100 that is described with respect to FIG. 11. FIG. 13 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1302, the method 1300 can include determining that a velocity of an image capture device to capture the plurality of scanned images (e.g., the plurality of two-dimensional scanned images) does not exceed a scanned image capture velocity threshold. The scanned image capture velocity can be a velocity at which the image capture device is moved while capturing the plurality of scanned images that does not result in the plurality of scanned images being blurred. For example, the computing device 102 can determine, based on motion sensors of an image capture device, that the image capture device does not exceed a scanned image capture velocity threshold.

At 1304, the method 1300 can include determining that an image capture rate of the image capture device to capture the plurality of scanned images does not exceed a scanned image capture rate threshold. For example, the computing device 102 can determine, based on detection of the state of an image capture device's image capture sensor (e.g., optical sensor) and/or image capture buffer, that the image capture rate of the image capture device does not exceed a scanned image capture rate threshold.

At 1306, the method 1300 can include determining one or more directions in which to position the image capture device to capture the plurality of scanned images (e.g., the plurality of two-dimensional scanned images). For example, the computing device 102 can input the image data into one or more machine-learned models that are configured and/or trained to one or more directions in which to position the image capture device to capture the plurality of scanned images.

At 1308, the method 1300 can include determining a portion of a predetermined field of view of the physical space from each of the plurality of scan nodes that has been captured. For example, the computing device 102 can process the plurality of scanned images (e.g., the plurality of two-dimensional scanned images) of a physical space and determine the portion of the volume of a three-dimensional physical space that has been captured by the image capture devices that generated the plurality of scanned images.

At 1310, the method 1300 can include generating one or more indications of the portion of the predetermined field of view of the physical space from each of the plurality of scan nodes that has been captured. For example, the computing device 102 can generate one or more indications that indicate the portion (e.g., a percentage and/or a graphical completion bar that increases in size based on the portion of the physical space at a scan node that has been captured) of the physical space for which the plurality of scanned images have been captured and/or generated.

Further to the descriptions above, a user may be provided with controls allowing the user to make an election as to both if and/or when systems, programs, or features described herein may enable collection of user information (e.g., image information), and if the user is sent data or communications from a server. In addition, certain data may be treated in one or more ways before it is stored or used, so that certain information of a user may be removed. For example, a user's identity may be treated so that certain other information associated with the user's identity may not be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The technology discussed herein makes reference to servers, databases, software applications, and other computer-based systems, as well as actions taken and information sent to and from such systems. The inherent flexibility of computer-based systems allows for a wide variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A computer-implemented method of generating reconstructed three-dimensional representations, the computer-implemented method comprising:
receiving, by a computing system comprising one or more processors, image data comprising a plurality of two-dimensional images associated with a path through a physical space;
determining, by the computing system, based on the image data, a plurality of scan nodes associated with the path, wherein the plurality of scan nodes comprise locations at which to capture a plurality of two-dimensional scanned images of the physical space;
generating, by the computing system, based on the plurality of scan nodes, a plurality of instructions associated with capturing the plurality of two-dimensional scanned images of the physical space;
generating, by the computing system, based on the plurality of instructions, the plurality of two-dimensional scanned images associated with the plurality of scan nodes; and
generating, by the computing system, based on the image data and the plurality of two-dimensional scanned images, a reconstructed three-dimensional representation of the physical space.

2. The computer-implemented method of claim 1, further comprising:
generating, by the computing system, the image data based on one or more directions to traverse the path through the physical space.

3. The computer-implemented method of claim 1, further comprising:
determining, by the computing system, based on the image data, the path through the physical space.

4. The computer-implemented method of claim 1, wherein the determining, by the computing system, a plurality of scan nodes associated with the path, wherein the plurality of scan nodes comprise locations at which to capture a plurality of two-dimensional scanned images of the physical space comprises:
determining, by the computing system, based on the image data, estimated dimensions of the physical space.

5. The computer-implemented method of claim 4, wherein the estimated dimensions of the physical space are based on inputting the image data into one or more machine-learned models that are configured to determine three-dimensional features based on detection of two-dimensional features of the two-dimensional images.

6. The computer-implemented method of claim 1, wherein the determining, by the computing system, a plurality of scan nodes associated with the path, wherein the plurality of scan nodes comprise locations at which to capture a plurality of two-dimensional scanned images of the physical space comprises:
determining, by the computing system, based on the image data, the plurality of scan nodes comprising locations from which a field of view to capture the plurality of two-dimensional scanned images is not occluded by one or more objects.

7. The computer-implemented method of claim 1, wherein the determining, by the computing system, a plurality of scan nodes associated with the path, wherein the plurality of scan nodes comprise locations at which to capture a plurality of two-dimensional scanned images of the physical space comprises:
determining, by the computing system, based on the image data, the plurality of scan nodes comprising locations from which capture of the plurality of two-dimensional scanned images is not obstructed by one or more objects.

8. The computer-implemented method of claim 1, wherein the plurality of instructions comprise an instruction to capture the plurality of two-dimensional scanned images comprising a substantially omnidirectional field of view from each of the plurality of scan nodes.

9. The computer-implemented method of claim 1, wherein the generating, by the computing system, based on the plurality of instructions, the plurality of two-dimensional scanned images associated with the plurality of scan nodes comprises:
determining, by the computing system, that a velocity of an image capture device that captures the plurality of two-dimensional scanned images does not exceed a scanned image capture velocity threshold;
determining, by the computing system, that an image capture rate of the image capture device that captures the plurality of two-dimensional scanned images does not exceed a scanned image capture rate threshold; or
determining, by the computing system, one or more directions in which to position the image capture device to capture the plurality of two-dimensional scanned images.

10. The computer-implemented method of claim 1, wherein the generating, by the computing system, based on the plurality of instructions, the plurality of two-dimensional scanned images associated with the plurality of scan nodes comprises:
determining, by the computing system, a portion of a predetermined field of view of the physical space from each of the plurality of scan nodes that has been captured; and
generating, by the computing system, one or more indications of the portion of the predetermined field of view of the physical space from each of the plurality of scan nodes that has been captured.

11. The computer-implemented method of claim 1, further comprising:
generating, by the computing system, an augmented reality environment based on the reconstructed three-dimensional representation.

12. The computer-implemented method of claim 1, wherein the reconstructed three-dimensional representation is based on performance of one or more Gaussian splatting techniques on the plurality of two-dimensional images or the plurality of two-dimensional scanned images.

13. The computer-implemented method of claim 1, wherein the reconstructed three-dimensional representation is based on inputting the image data and the plurality of two-dimensional scanned images into one or more machine-learned models configured to generate the reconstructed three-dimensional representation.

14. The computer-implemented method of claim 13, wherein the one or more machine-learned models comprise a neural radiance field (NeRF) model.

15. The computer-implemented method of claim 1, wherein the plurality of two-dimensional scanned images are captured by one or more image capture devices comprising one or more cameras, a smartphone, or an augmented reality headset.

16. One or more tangible non-transitory computer-readable media storing computer-readable instructions that when executed by one or more processors cause the one or more processors to perform operations, the operations comprising:
receiving image data comprising a plurality of two-dimensional images associated with a path through a physical space;
determining, based on the image data, a plurality of scan nodes associated with the path, wherein the plurality of scan nodes comprise locations at which to capture a plurality of two-dimensional scanned images of the physical space;
generating, based on the plurality of scan nodes, a plurality of instructions associated with capturing the plurality of two-dimensional scanned images of the physical space;
generating, based on the plurality of instructions, the plurality of two-dimensional scanned images associated with the plurality of scan nodes; and
generating, based on the image data and the plurality of two-dimensional scanned images, a reconstructed three-dimensional representation of the physical space.

17. The one or more tangible non-transitory computer-readable media of claim 16, wherein the reconstructed three-dimensional representation is based on performance of one or more Gaussian splatting techniques on the plurality of two-dimensional images or the plurality of two-dimensional scanned images.

18. A computing system comprising:
one or more processors;
one or more non-transitory computer-readable media storing instructions that when executed by the one or more processors cause the one or more processors to perform operations comprising:
receiving image data comprising a plurality of two-dimensional images associated with a path through a physical space;
determining, based on the image data, a plurality of scan nodes associated with the path, wherein the plurality of scan nodes comprise locations at which to capture a plurality of two-dimensional scanned images of the physical space;
generating, based on the plurality of scan nodes, a plurality of instructions associated with capturing the plurality of two-dimensional scanned images of the physical space;
generating, based on the plurality of instructions, the plurality of two-dimensional scanned images associated with the plurality of scan nodes; and
generating, based on the image data and the plurality of two-dimensional scanned images, a reconstructed three-dimensional representation of the physical space.

19. The computing system of claim 18, wherein the plurality of instructions comprise an instruction to capture the plurality of two-dimensional scanned images comprising a substantially omnidirectional field of view from each of the plurality of scan nodes.

20. The computing system of claim 18, wherein the reconstructed three-dimensional representation is based on performance of one or more Gaussian splatting techniques on the plurality of two-dimensional images or the plurality of two-dimensional scanned images.
